(19) United States
(12) Patent Application Publication
(10) Pub. No.: US 2025/0096943 A1
(43) Pub. Date: Mar. 20, 2025

(54) MODIFYING A HYBRID AUTOMATIC REPEAT REQUEST ACKNOWLEDGEMENT (HARQ-ACK) PAYLOAD PRIOR TO FORMING A TWO PART HARQ-ACK

(71) Applicant: QUALCOMM Incorporated, San Diego, CA (US)

(72) Inventors: Mostafa KHOSHNEVISAN, San Diego, CA (US); Jing SUN, San Diego, CA (US)

(21) Appl. No.: 18/471,238

(22) Filed: Sep. 20, 2023

(51) Int. Cl. H04L 1/1607; H04L 1/1812; H04L 1/1829

(52) U.S. Cl. CPC H04L 1/1621; H04L 1/1812; H04L 1/1861

(57) ABSTRACT

A method for wireless communication by a UE includes receiving, from a network node, a group of downlink transmissions. The method also includes forming a first HARQ-ACK part and a second HARQ-ACK part associated with an original HARQ-ACK payload in accordance with satisfying a forming condition. The original HARQ-ACK payload may include HARQ feedback for each one of the group of downlink transmissions. A size of the second HARQ-ACK part is a function of the first HARQ-ACK part. The method also includes separately encoding the first HARQ-ACK part and the second HARQ-ACK part. The method further includes transmitting the encoded first HARQ-ACK part and the encoded second HARQ-ACK part.

### FIELD OF THE DISCLOSURE

The present disclosure relates generally to hybrid automatic repeat request acknowledgement (HARQ-ACK) feedback during wireless communication, and more specifically to modifying a HARQ-ACK payload prior to forming a two part HARQ-ACK payload.

### BACKGROUND

Wireless communications systems are widely deployed to provide various telecommunications services such as telephony, video, data, messaging, and broadcasts. Typical wireless communications systems may employ multiple-access technologies capable of supporting communications with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and long term evolution (LTE). LTE/LTE-Advanced is a set of enhancements to the universal mobile telecommunications system (UMTS) mobile standard promulgated by the Third Generation Partnership Project (3GPP). Narrowband (NB)-Internet of things (IoT) and enhanced machine-type communications (eMTC) are a set of enhancements to LTE for machine type communications.

A wireless communications network may include a number of base stations (BSs) that can support communications for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail, a BS may be referred to as a Node B, an evolved Node B (eNB), a gNB, an access point (AP), a radio head, a transmit and receive point (TRP), a new radio (NR) BS, a 5G Node B, and/or the like.

The above multiple access technologies have been adopted in various telecommunications standards to provide a common protocol that enables different user equipment to communicate on a municipal, national, regional, and even global level. New radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation.

### SUMMARY

In one aspect of the present disclosure, a method for wireless communication at a UE includes receiving, from a network node, a group of downlink transmissions. The method also includes forming, from an original HARQ-ACK payload, a first HARQ-ACK part and a second HARQ-ACK part in accordance with satisfying a forming condition, the original HARQ-ACK payload including HARQ feedback for each one of the group of downlink transmissions, a size of the second HARQ-ACK part being a function of the first HARQ-ACK part. The method also includes separately encoding the first HARQ-ACK part and the second HARQ-ACK part. The method further includes transmitting the encoded first HARQ-ACK part and the encoded second HARQ-ACK part.

Another aspect of the present disclosure is directed to an apparatus including means for receiving, from a network node, a group of downlink transmissions. The apparatus further includes means for forming, from an original HARQ-ACK payload, a first HARQ-ACK part and a second HARQ-ACK part in accordance with satisfying a forming condition, the original HARQ-ACK payload including HARQ feedback for each one of the group of downlink transmissions, a size of the second HARQ-ACK part being a function of the first HARQ-ACK part. The apparatus also includes means for separately encoding the first HARQ-ACK part and the second HARQ-ACK part. The apparatus further includes means for transmitting the encoded first HARQ-ACK part and the encoded second HARQ-ACK part.

In another aspect of the present disclosure, a non-transitory computer-readable medium with non-transitory program code recorded thereon is disclosed. The program code is executed by one or more processors and includes program code to receive, from a network node, a group of downlink transmissions. The program code also includes program code to form, from an original HARQ-ACK payload, a first HARQ-ACK part and a second HARQ-ACK part in accordance with satisfying a forming condition, the original HARQ-ACK payload including HARQ feedback for each one of the group of downlink transmissions, a size of the second HARQ-ACK part being a function of the first HARQ-ACK part. The program code also includes program code to separately encode the first HARQ-ACK part and the second HARQ-ACK part. The program code further includes program code to transmit the encoded first HARQ-ACK part and the encoded second HARQ-ACK part.

Another aspect of the present disclosure is directed to a UE including one or more processors, and one or more memories coupled with the one or more processors and storing processor-executable code that, when executed by the one or more processors, is configured to receive, from a network node, a group of downlink transmissions. Execution of the processor-executable code also cause the UE to form, from an original HARQ-ACK payload, a first HARQ-ACK part and a second HARQ-ACK part in accordance with satisfying a forming condition, the original HARQ-ACK payload including HARQ feedback for each one of the group of downlink transmissions, a size of the second HARQ-ACK part being a function of the first HARQ-ACK part. Execution of the processor-executable code also cause the UE to separately encode the first HARQ-ACK part and the second HARQ-ACK part. Execution of the processor-executable code further cause the UE to transmit the encoded first HARQ-ACK part and the encoded second HARQ-ACK part.

In one aspect of the present disclosure, a method for wireless communication at a UE includes receiving, from a network node, a group of downlink transmissions. The method further includes modifying an original HARQ-ACK payload that includes HARQ feedback for each one of the group of downlink transmissions. The method also includes forming, from the modified original HARQ-ACK payload, a first HARQ-ACK part and a second HARQ-ACK part, a size of the second HARQ-ACK part being a function of the first HARQ-ACK part. The method further includes separately encoding the first HARQ-ACK part and the second HARQ-ACK part. The method still further includes transmitting the encoded first HARQ-ACK part and the encoded second HARQ-ACK part.

Another aspect of the present disclosure is directed to an apparatus including means for receiving, from a network node, a group of downlink transmissions. The apparatus further includes means for modifying an original HARQ-ACK payload that includes HARQ feedback for each one of the group of downlink transmissions. The apparatus also includes means for forming, from the modified original HARQ-ACK payload, a first HARQ-ACK part and a second HARQ-ACK part, a size of the second HARQ-ACK part being a function of the first HARQ-ACK part. The apparatus further includes means for separately encoding the first HARQ-ACK part and the second HARQ-ACK part. The apparatus still further includes means for transmitting the encoded first HARQ-ACK part and the encoded second HARQ-ACK part.

In another aspect of the present disclosure, a non-transitory computer-readable medium with non-transitory program code recorded thereon is disclosed. The program code is executed by one or more processors and includes program code to receive, from a network node, a group of downlink transmissions. The program code further includes program code to modify an original HARQ-ACK payload that includes HARQ feedback for each one of the group of downlink transmissions. The program code also includes program code to form, from the modified original HARQ-ACK payload, a first HARQ-ACK part and a second HARQ-ACK part, a size of the second HARQ-ACK part being a function of the first HARQ-ACK part. The program code further includes program code to separately encode the first HARQ-ACK part and the second HARQ-ACK part. The program code still further includes program code to transmit the encoded first HARQ-ACK part and the encoded second HARQ-ACK part.

Another aspect of the present disclosure is directed to a UE including one or more processors, and one or more memories coupled with the one or more processors and storing processor-executable code that, when executed by the one or more processors, is configured to receive, from a network node, a group of downlink transmissions. Execution of the processor-executable code also cause the UE to modify an original HARQ-ACK payload that includes HARQ feedback for each one of the group of downlink transmissions. Execution of the processor-executable code further cause the UE to form, from the modified original HARQ-ACK payload, a first HARQ-ACK part and a second HARQ-ACK part, a size of the second HARQ-ACK part being a function of the first HARQ-ACK part. Execution of the processor-executable code also cause the UE to separately encode the first HARQ-ACK part and the second HARQ-ACK part. Execution of the processor-executable code also cause the UE to transmit the encoded first HARQ-ACK part and the encoded second HARQ-ACK part.

In one aspect of the present disclosure, a method for wireless communication at a UE includes receiving, from a network node, a group of downlink transmissions. The method further includes generating, from an original HARQ-ACK payload, a first portion and a second portion, the original HARQ-ACK payload including HARQ feedback for each one of the group of downlink transmissions. The method also includes forming, from the second portion, a first HARQ-ACK part and a second HARQ-ACK part, a size of the second HARQ-ACK part being a function of the first HARQ-ACK part. The method further includes transmitting the first HARQ-ACK part, the second HARQ-ACK part, and the first portion in accordance with the forming.

Another aspect of the present disclosure is directed to an apparatus including means for receiving, from a network node, a group of downlink transmissions. The apparatus further includes means for generating, from an original HARQ-ACK payload, a first portion and a second portion, the original HARQ-ACK payload including HARQ feedback for each one of the group of downlink transmissions. The apparatus also includes means for forming, from the second portion, a first HARQ-ACK part and a second HARQ-ACK part, a size of the second HARQ-ACK part being a function of the first HARQ-ACK part. The apparatus further includes means for transmitting the first HARQ-ACK part, the second HARQ-ACK part, and the first portion in accordance with the forming.

In another aspect of the present disclosure, a non-transitory computer-readable medium with non-transitory program code recorded thereon is disclosed. The program code is executed by one or more processors and includes program code to receive, from a network node, a group of downlink transmissions. The program code also includes program code to generate, from an original HARQ-ACK payload, a first portion and a second portion, the original HARQ-ACK payload including HARQ feedback for each one of the group of downlink transmissions. The program code further includes program code to form, from the second portion, a first HARQ-ACK part and a second HARQ-ACK part, a size of the second HARQ-ACK part being a function of the first HARQ-ACK part. The program code still further includes program code to transmit the first HARQ-ACK part, the second HARQ-ACK part, and the first portion in accordance with the forming.

Another aspect of the present disclosure is directed to a UE including one or more processors, and one or more memories coupled with the one or more processors and storing processor-executable code that, when executed by the one or more processors, is configured to receive, from a network node, a group of downlink transmissions. Execution of the processor-executable code also cause the UE to generate, from an original HARQ-ACK payload, a first portion and a second portion, the original HARQ-ACK payload including HARQ feedback for each one of the group of downlink transmissions. Execution of the processor-executable code further cause the UE to form, from the second portion, a first HARQ-ACK part and a second HARQ-ACK part, a size of the second HARQ-ACK part being a function of the first HARQ-ACK part. Execution of the processor-executable code also cause the UE to transmit the first HARQ-ACK part, the second HARQ-ACK part, and the first portion in accordance with the forming.

Aspects generally include a method, apparatus, system, computer program product, non-transitory computer-readable medium, user equipment, base station, wireless communication device, and processing system as substantially described with reference to and as illustrated by the accompanying drawings and specification.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that features of the present disclosure can be understood in detail, a particular description may be had by reference to aspects, some of which are illustrated in the appended drawings. It is to be noted, however, that the appended drawings illustrate only certain aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communications network, in accordance with various aspects of the present disclosure.

FIG. 2 is a block diagram conceptually illustrating an example of a base station in communication with a user equipment (UE) in a wireless communications network, in accordance with various aspects of the present disclosure.

FIG. 3 is a block diagram illustrating an example disaggregated base station architecture, in accordance with various aspects of the present disclosure.

FIG. 4 is a call flow diagram illustrating an example of two part hybrid automatic repeat request acknowledgement (HARQ-ACK) transmission, in accordance with various aspects of the present disclosure.

FIG. 5 is a block diagram illustrating an example of forming two HARQ-ACK parts based on an initial HARQ-ACK payload, in accordance with various aspects of the present disclosure.

FIG. 6 is a block diagram illustrating an example of forming two HARQ-ACK parts based on HARQ-ACK payload segments, in accordance with various aspects of the present disclosure.

FIG. 7A is a block diagram illustrating an example of selecting a physical uplink shared channel (PUSCH) for a second HARQ-ACK part, in accordance with various aspects of the present disclosure.

FIG. 7B is a block diagram illustrating an example of a group of pending second HARQ-ACK parts, in accordance with various aspects of the present disclosure.

FIG. 7C is a block diagram illustrating an example of multiplexing HARQ-ACK parts from different HARQ-ACK payloads, in accordance with various aspects of the present disclosure.

FIGS. 8A and 8B are block diagrams illustrating examples of modifying an original HARQ-ACK payload, in accordance with various aspects of the present disclosure.

FIG. 9 is a block diagram illustrating lossy compression encoding and decoding, in accordance with various aspects of the present disclosure.

FIG. 10 is a block diagram illustrating bundling and source decoding, in accordance with various aspects of the present disclosure.

FIG. 11 is a table illustrating bundling size dependencies, in accordance with various aspects of the present disclosure.

FIG. 12 is a block diagram illustrating partitioning and source decoding, in accordance with various aspects of the present disclosure.

FIG. 13 is a table mapping codewords to group indexes, while showing distortion levels corresponding to reconstructed bits, in accordance with various aspects of the present disclosure.

FIG. 14 is a portion of the table shown in FIG. 13, mapping codewords to group indexes, in accordance with various aspects of the present disclosure.

FIG. 15 is a block diagram illustrating concatenating of bundling and two part HARQ-ACK compression, in accordance with various aspects of the present disclosure.

FIG. 16 is a block diagram illustrating segmenting of bundled HARQ-ACK bits, in accordance with various aspects of the present disclosure.

FIG. 17 is a block diagram illustrating concatenating of partitioning and two part HARQ-ACK compression, in accordance with various aspects of the present disclosure.

FIG. 18 is a diagram illustrating different types of negative acknowledgement (NACK) events, in accordance with various aspects of the present disclosure.

FIG. 19 is a diagram illustrating examples of bundling positive acknowledgement/negative acknowledgement (ACK/NACK) bits, in accordance with various aspects of the present disclosure.

FIG. 20 is a table illustrating example codepoints for jointly encoding a bundling result with information related to a number of acknowledgements (ACKs), in accordance with various aspects of the present disclosure.

FIG. 21 illustrates examples of reporting a number of ACKs with two part HARQ-ACK compression, in accordance with various aspects of the present disclosure.

FIG. 22 illustrates examples of reporting a number of ACKs for lossy compression with bundling, in accordance with various aspects of the present disclosure.

FIGS. 23, 24, and 25 are flow diagrams illustrating examples of modifying a HARQ-ACK payload prior to forming two HARQ-ACK parts, in accordance with various aspects of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method, which is practiced using other structure, functionality, or structure and functionality in addition to or other than the various aspects of the disclosure set forth. It should be understood that any aspect of the disclosure disclosed may be embodied by one or more elements of a claim.

Several aspects of telecommunications systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described using terminology commonly associated with 5G and later wireless technologies, aspects of the present disclosure can be applied in other generation-based communications systems, such as and including 3G and/or 4G technologies.

Wireless communications may be unreliable at times. Techniques, such as hybrid automatic repeat request (HARQ), may help recover transmission errors by allowing a receiver to indicate to a transmitter whether a data transmission such as a code block (CB), code block group (CBG), or a transport block (TB) has been correctly decoded. The receiver may send an acknowledgement (ACK) in response to correctly decoding the transmission and may send a negative acknowledgement (NACK) in response to failing to decode the transmission. The transmitter may retransmit the transmission in response to receiving a NACK, such that the receiver may correctly decode the retransmission. In some cases, multiple retransmissions may occur. The resources for hybrid automatic repeat request acknowledgment (HARQ-ACK) feedback, which may be carried in a physical uplink control channel (PUCCH) or physical uplink shared channel (PUSCH), are significant. It would be desirable to reduce the number of bits allocated for HARQ-ACK feedback in the PUCCH.

Lossless compression for HARQ-ACK feedback provides a significant overhead reduction compared to standard HARQ-ACK feedback. Close to optimal compression or entropy can be obtained with two part or two stage HARQ-ACK compression. One or two bits in the first part may be generally sufficient. In the simplest form of lossless compression, the first part (e.g., part 1) of the two part HARQ-ACK payload has one bit. In some examples, the transmitter sets the single bit to ‘1’ if all received code blocks are successfully decoded (e.g., all ACK). In such examples, nothing is sent for the second part of the two part HARQ-ACK payload (e.g., part 2). Otherwise, in such examples, the transmitter sets the single bit in the first part to ‘0’, and sends the full payload in the second part of the two part HARQ-ACK payload.

In some cases, a HARQ-ACK payload may include one or more dummy NACKs (e.g., d-NACKs). The d-NACKs may also be referred to as default NACKs. A d-NACK is not a low probability occurrence because the d-NACK is not associated with a decoding failure, such as a DCI decoding failure, a PDSCH decoding failure, or a PDCCH decoding failure. Rather, the d-NACK may be based on one or more scheduling decisions by a network node, such that the d-NACK may occur more frequently than an actual NACK that is associated with a decoding failure. Specifically, the d-NACK is a type of NACK (represented as ‘0’) added to the HARQ-ACK payload to ensure the payload sizes (e.g., codebook sizes) between the UE and the network node match. As a result, compression schemes, such as the two part HARQ-ACK compression scheme, may fail to adequately compress the HARQ-ACK payload in the presence of d-NACKs. The d-NACK may be used in different types of HARQ-ACK payload types, such as Type1, Type2, and Type3.

Various aspects of the present disclosure are directed to using a two part HARQ-ACK compression scheme when an original HARQ-ACK payload includes one or more d-NACKs. In some examples, the original HARQ-ACK payload may be transformed into a first HARQ-ACK part and a second HARQ-ACK part if a forming condition is satisfied. In some such examples, the forming condition may be based on a HARQ-ACK payload type, whether a code block group (CBG)-based PDSCH reception is configured, a maximum number of codewords in a PDSCH, or whether spatial bundling is configured. In other examples, one or more d-NACKs in the original HARQ-ACK payload may be changed to a dummy ACK (e.g., default ACK) prior to forming the two HARQ-ACK parts. In other examples, the original HARQ-ACK payload may be divided into a first partition and a second partition. In such examples, the two HARQ-ACK parts may be formed from one of the partitions.

Particular aspects of the subject matter described in this disclosure can be implemented to realize one or more of the following potential advantages. In some examples, the described techniques allow for transforming an original HARQ-ACK payload to a two part HARQ-ACK payload when the original HARQ-ACK payload includes one or more d-NACKs. The use of the two part HARQ-ACK payload may reduce a size of the HARQ-ACK payload, thereby reducing network bandwidth.

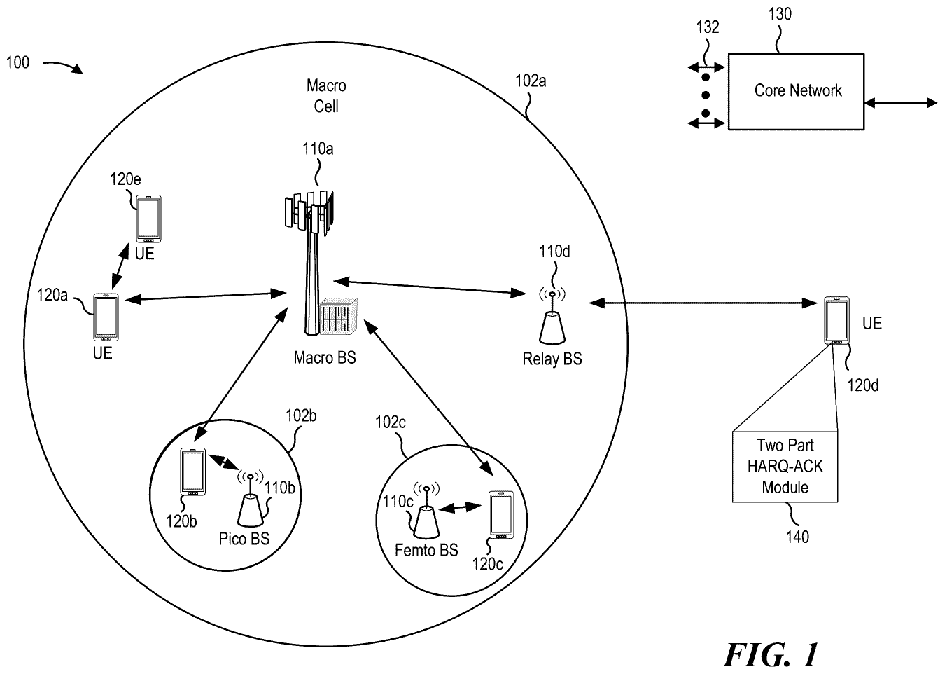

FIG. 1 is a diagram illustrating a wireless network 100 in which aspects of the present disclosure may be practiced. The wireless network 100 may be a 5G or NR network or some other wireless network, such as an LTE network. The wireless network 100 may include a number of BSs 110 (shown as BS 110a, BS 110b, BS 110c, and BS 110d) and other network entities. A BS is an entity that communicates with user equipment (UEs) and may also be referred to as a base station, an NR BS, a Node B, a gNB, a 5G Node B, an access point, a transmit and receive point (TRP), a network node, a network entity, and/or the like. A base station can be implemented as an aggregated base station, as a disaggregated base station, an integrated access and backhaul (IAB) node, a relay node, a sidelink node, etc. The base station can be implemented in an aggregated or monolithic base station architecture, or alternatively, in a disaggregated base station architecture, and may include one or more of a central unit (CU), a distributed unit (DU), a radio unit (RU), a near-real time (near-RT) RAN intelligent controller (RIC), or a non-real time (non-RT) RIC.

Each BS may provide communications coverage for a particular geographic area. In 3GPP, the term “cell” can refer to a coverage area of a BS and/or a BS subsystem serving this coverage area, depending on the context in which the term is used.

A BS may provide communications coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB,” “base station,” “NR BS,” “gNB,” “AP,” “Node B,” “5G NB,” “TRP,” and “cell” may be used interchangeably.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

The wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communications between the BS 110a and UE 120d. A relay station may also be referred to as a relay BS, a relay base station, a relay, and/or the like.

The wireless network 100 may be a heterogeneous network that includes BSs of different types (e.g., macro BSs, pico BSs, femto BSs, relay BSs, and/or the like). These different types of BSs may have different transmit power levels, different coverage areas, and different impact on interference in the wireless network 100. For example, macro BSs may have a high transmit power level (e.g., 5 to 40 watts) whereas pico BSs, femto BSs, and relay BSs may have lower transmit power levels (e.g., 0.1 to 2 watts).

As an example, the BSs 110 (shown as BS 110a, BS 110b, BS 110c, and BS 110d) and the core network 130 may exchange communications via backhaul links 132 (e.g., S1, etc.). Base stations 110 may communicate with one another over other backhaul links (e.g., X2, etc.) either directly or indirectly (e.g., through core network 130).

The core network 130 may be an evolved packet core (EPC), which may include at least one mobility management entity (MME), at least one serving gateway (S-GW), and at least one packet data network (PDN) gateway (P-GW). The MME may be the control node that processes the signaling between the UEs 120 and the EPC. All user IP packets may be transferred through the S-GW, which itself may be connected to the P-GW. The P-GW may provide IP address allocation as well as other functions. The P-GW may be connected to the network operator's IP services. The operator's IP services may include the Internet, the Intranet, an IP multimedia subsystem (IMS), and a packet-switched (PS) streaming service.

The core network 130 may provide user authentication, access authorization, tracking, IP connectivity, and other access, routing, or mobility functions. One or more of the base stations 110 or access node controllers (ANCs) may interface with the core network 130 through backhaul links 132 (e.g., S1, S2, etc.) and may perform radio configuration and scheduling for communications with the UEs 120. In some configurations, various functions of each access network entity or base station 110 may be distributed across various network devices (e.g., radio heads and access network controllers) or consolidated into a single network device (e.g., a base station 110).

UEs 120 (e.g., 120a, 120b, 120c) may be dispersed throughout the wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

One or more UEs 120 may establish a protocol data unit (PDU) session for a network slice. In some cases, the UE 120 may select a network slice based on an application or subscription service. By having different network slices serving different applications or subscriptions, the UE 120 may improve its resource utilization in the wireless network 100, while also satisfying performance specifications of individual applications of the UE 120. In some cases, the network slices used by UE 120 may be served by an AMF (not shown in FIG. 1) associated with one or both of the base station 110 or core network 130. In addition, session management of the network slices may be performed by an access and mobility management function (AMF).

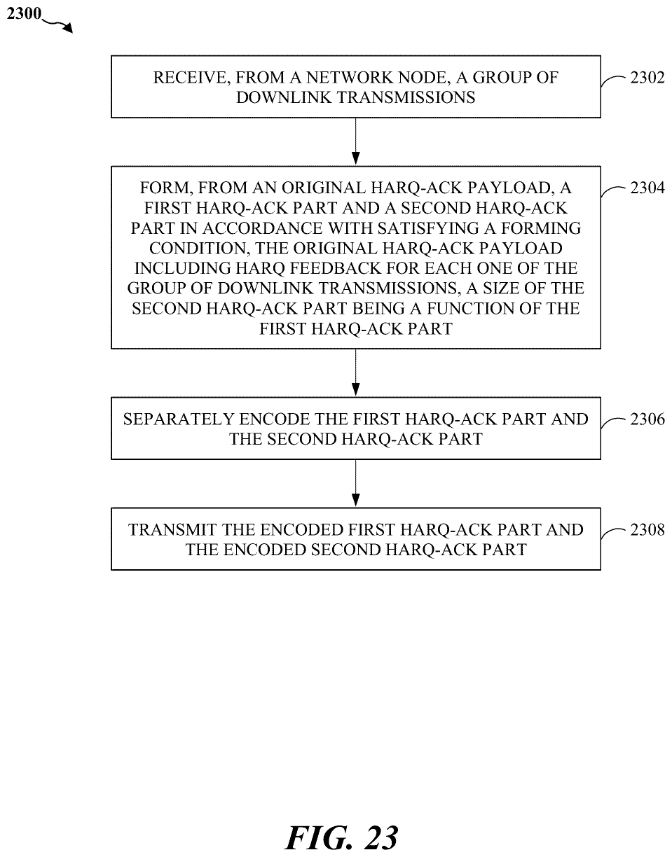

The UEs 120 may include a two part HARQ-ACK module 140. For brevity, only one UE 120d is shown as including the two part HARQ-ACK module 140. The two part HARQ-ACK module 140 may perform one or more operations, such as one or more operations discussed with reference to the process 2300, 2400, and/or 2500 described with reference to FIGS. 23-25, respectively.

Some UEs may be considered machine-type communications (MTC) or evolved or enhanced machine-type communications (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UES may be considered Internet-of-Things (IoT) devices, and/or may be implemented as NB-IoT (narrowband internet of things) devices. Some UEs may be considered a customer premises equipment (CPE). UE 120 may be included inside a housing that houses components of UE 120, such as processor components, memory components, and/or the like.

In general, any number of wireless networks may be deployed in a given geographic area. Each wireless network may support a particular radio access technology (RAT) and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere as being performed by the base station 110. For example, the base station 110 may configure a UE 120 via downlink control information (DCI), radio resource control (RRC) signaling, a media access control-control element (MAC-CE) or via system information (e.g., a system information block (SIB).

As indicated above, FIG. 1 is provided merely as an example. Other examples may differ from what is described with regard to FIG. 1.

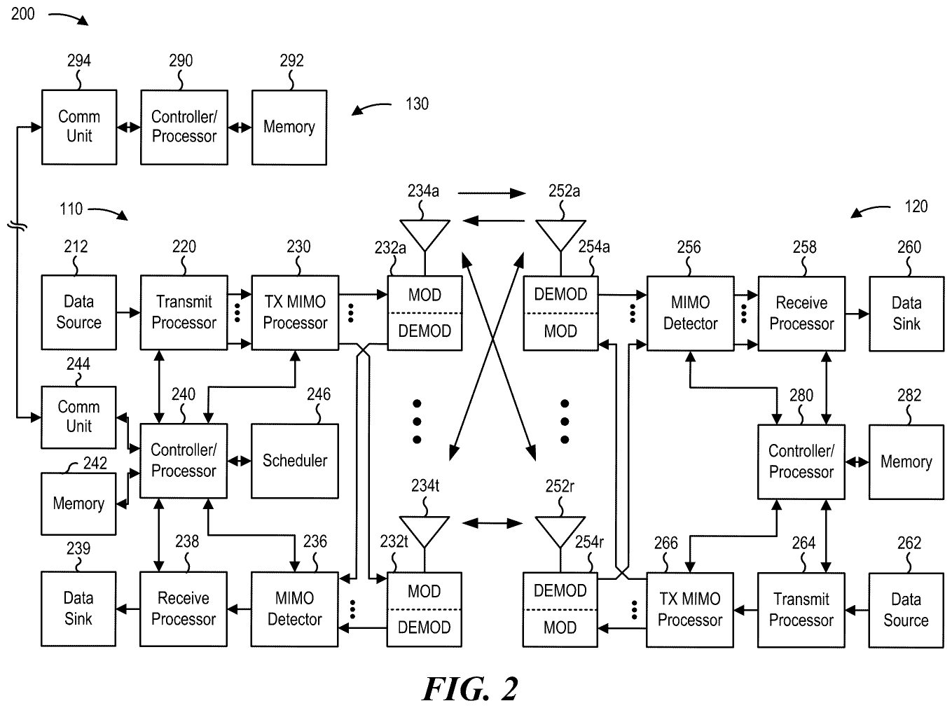

FIG. 2 shows a block diagram of a design 200 of the base station 110 and UE 120, which may be one of the base stations and one of the UEs in FIG. 1. The base station 110 may be equipped with T antennas 234a through 234t, and UE 120 may be equipped with R antennas 252a through 252r, where in general T≥1 and R≥1.

At the base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Decreasing the MCS lowers throughput but increases reliability of the transmission. The transmit processor 220 may also process system information (e.g., for semi-static resource partitioning information (SRPI) and/or the like) and control information (e.g., CQI requests, grants, upper layer signaling, and/or the like) and provide overhead symbols and control symbols. The transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for orthogonal frequency division multiplexing (OFDM) and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At the UE 120, antennas 252a through 252r may receive the downlink signals from the base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for the UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of the UE 120 may be included in a housing.

On the uplink, at the UE 120, a transmit processor 264 may receive and process data from a data source 262 and control information (e.g., for reports comprising RSRP, RSSI, RSRQ, CQI, and/or the like) from the controller/processor 280. Transmit processor 264 may also generate reference symbols for one or more reference signals. The symbols from the transmit processor 264 may be precoded by a TX MIMO processor 266 if applicable, further processed by modulators 254a through 254r (e.g., for discrete Fourier transform spread OFDM (DFT-s-OFDM), CP-OFDM, and/or the like), and transmitted to the base station 110. At the base station 110, the uplink signals from the UE 120 and other UEs may be received by the antennas 234, processed by the demodulators 254, detected by a MIMO detector 236 if applicable, and further processed by a receive processor 238 to obtain decoded data and control information sent by the UE 120. The receive processor 238 may provide the decoded data to a data sink 239 and the decoded control information to a controller/processor 240. The base station 110 may include communications unit 244 and communicate to the core network 130 via the communications unit 244. The core network 130 may include a communications unit 294, a controller/processor 290, and a memory 292.

The controller/processor 240 of the base station 110, the controller/processor 280 of the UE 120, and/or any other component(s) of FIG. 2 may perform one or more techniques associated with forming a two part HARQ-ACK payload, as described in more detail elsewhere. For example, the controller/processor 240 of the base station 110, the controller/processor 280 of the UE 120, and/or any other component(s) of FIG. 2 may perform or direct operations of, for example, the processes of FIGS. 23-25 and/or other processes as described. Memories 242 and 282 may store data and program codes for the base station 110 and UE 120, respectively. A scheduler 246 may schedule UEs for data transmission on the downlink and/or uplink.

In some aspects, the UE 120 and/or base station 110 may include means for performing one or more operations, such as one or more operations discussed with reference to the process 2300, 2400, and/or 2500 described with reference to FIGS. 23-25, respectively. Such means may include one or more components of the UE 120 or base station 110 described in connection with FIG. 2.

As indicated above, FIG. 2 is provided merely as an example. Other examples may differ from what is described with regard to FIG. 2.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), an evolved NB (eNB), an NR BS, 5G NB, an access point (AP), a transmit and receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more Rus. Each of the CU, DU, and RU also can be implemented as virtual units (e.g., a virtual central unit (VCU), a virtual distributed unit (VDU), or a virtual radio unit (VRU)).

Base station-type operations or network designs may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

In some cases, different types of devices supporting different types of applications and/or services may coexist in a cell. Examples of different types of devices include UE handsets, customer premises equipment (CPEs), vehicles, Internet of Things (IoT) devices, and/or the like. Examples of different types of applications include ultra-reliable low-latency communications (URLLC) applications, massive machine-type communications (mMTC) applications, enhanced mobile broadband (eMBB) applications, vehicle-to-anything (V2X) applications, and/or the like. Furthermore, in some cases, a single device may support different applications or services simultaneously.

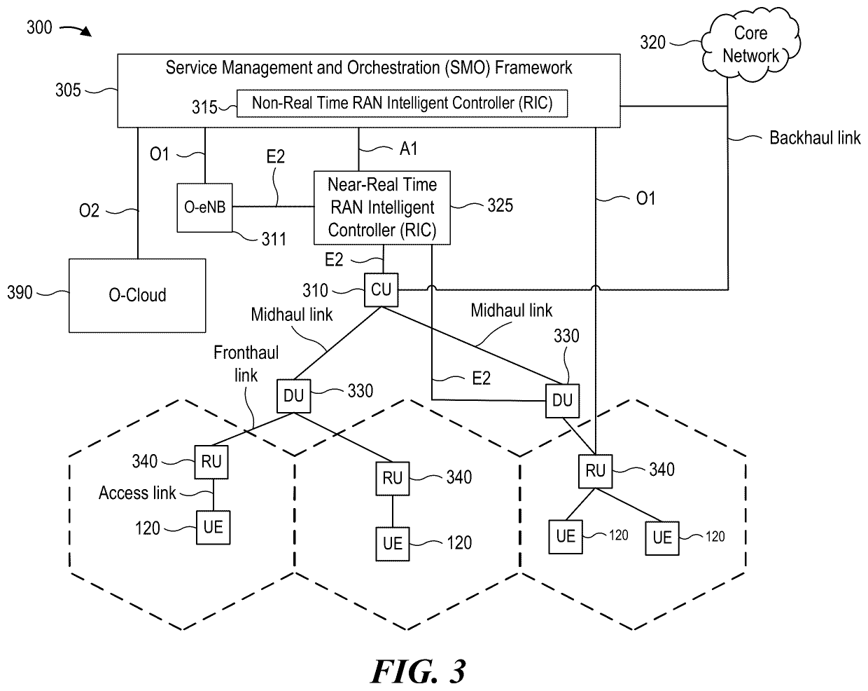

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a near-real time (near-RT) RAN intelligent controller (RIC) 325 via an E2 link, or a non-real time (non-RT) RIC 315 associated with a service management and orchestration (SMO) framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUs 310, the DUs 330, the RUs 340, as well as the near-RT RICs 325, the non-RT RICs 315, and the SMO framework 305) may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., central unit-user plane (CU-UP)), control plane functionality (e.g., central unit-control Plane (CU-CP)), or a combination thereof. In some implementations, the CU 310 can be logically split into one or more CU-UP units and one or more CU-CP units. The CU-UP unit can communicate bi-directionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the Third Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO framework 305 may be configured to support RAN deployment and provisioning of non-virtualized and virtualized network elements. For non-virtualized network elements, the SMO framework 305 may be configured to support the deployment of dedicated physical resources for RAN coverage requirements, which may be managed via an operations and maintenance interface (such as an O1 interface). For virtualized network elements, the SMO framework 305 may be configured to interact with a cloud computing platform (such as an open cloud (O-cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340, and near-RT RICs 325. In some implementations, the SMO framework 305 can communicate with a hardware aspect of a 4G RAN, such as an open eNB (O-eNB) 311, via an O1 interface. Additionally, in some implementations, the SMO framework 305 can communicate directly with one or more RUs 340 via an O1 interface. The SMO framework 305 also may include a non-RT RIC 315 configured to support functionality of the SMO framework 305.

The non-RT RIC 315 may be configured to include a logical function that enables non-real-time control and optimization of RAN elements and resources, artificial intelligence/machine learning (AI/ML) workflows including model training and updates, or policy-based guidance of applications/features in the near-RT RIC 325. The non-RT RIC 315 may be coupled to or communicate with (such as via an A1 interface) the near-RT RIC 325. The near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as the O-eNB 311, with the near-RT RIC 325.

In some implementations, to generate AI/ML models to be deployed in the near-RT RIC 325, the non-RT RIC 315 may receive parameters or external enrichment information from external servers. Such information may be utilized by the near-RT RIC 325 and may be received at the SMO framework 305 or the non-RT RIC 315 from non-network data sources or from network functions. In some examples, the non-RT RIC 315 or the near-RT RIC 325 may be configured to tune RAN behavior or performance. For example, the non-RT RIC 315 may monitor long-term trends and patterns for performance and employ AI/ML models to perform corrective actions through the SMO framework 305 (such as reconfiguration via O1) or via creation of RAN management policies (such as A1 policies).

Wireless communications may be unreliable at times. Techniques, such as hybrid automatic repeat request (HARQ), may help recover transmission errors by allowing a receiver to indicate to a transmitter whether a code block has been correctly decoded. The receiver may send an acknowledgement (ACK) in response to correctly decoding the code block and may send a negative acknowledgement (NACK) in response to not being able to decode the code block. The transmitter may retransmit the code block in response to receiving a NACK, with the hope that the code block may be correctly decoded during the retransmission. In some cases, multiple retransmissions may occur. The resources for hybrid automatic repeat request acknowledgment (HARQ-ACK) feedback, which may be carried in a physical uplink control channel (PUCCH), are significant. It would be desirable to reduce the number of bits in the PUCCH for carrying HARQ-ACK feedback.

The PUCCH has a variety of different formats in the fifth generation (5G) Third Generation Partnership Project (3GPP) specifications. Some PUCCH formats carry more than two bits, and some formats allow multiplexing. Format 0 defines a one or two symbol short PUCCH for up to two bits, with UE multiplexing in the same physical resource block (PRB). Format 1 defines a four to fourteen symbol long PUCCH for up to two bits, with UE multiplexing in the same PRB. Format 2 defines a one or two symbol short PUCCH for more than two bits, with no UE multiplexing in the same PRB. Format 3 defines a four to fourteen symbol long PUCCH for more than two bits, with no UE multiplexing in the same PRB. Format 4 defines a four to fourteen symbol long PUCCH for more than two bits, with UE multiplexing in the same PRB.

Three types of HARQ-ACK codebooks are defined in 5G 3GPP specifications, where a codebook is represented as a sequence of bits. The type-1 HARQ-ACK codebook is a semi-static codebook. The type-2 HARQ-ACK codebook is a dynamic codebook. The type-3 HARQ-ACK codebook is for one shot feedback.

For downlink (DL) transmission, a target block error rate (BLER) may be set at around ten percent. Thus, a large portion of the HARQ feedback will be positive acknowledgement (e.g., ACK), as opposed to negative acknowledgement (NACK). Based on this assumption, the number of HARQ-ACK bits in the feedback can be reduced.

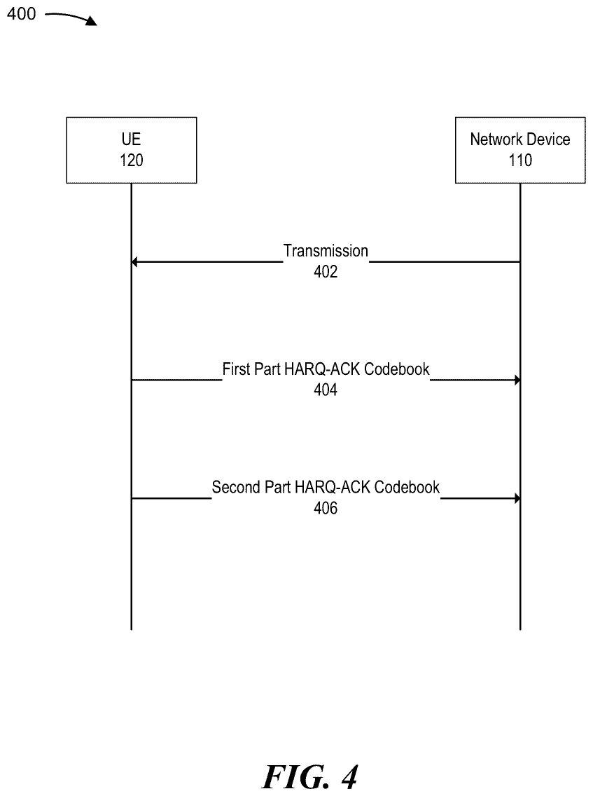

According to aspects of the present disclosure, lossless compression for HARQ-ACK feedback may be provided. FIG. 4 is a call flow diagram illustrating an example of two part hybrid automatic repeat request acknowledgement (HARQ-ACK) transmission, in accordance with various aspects of the present disclosure. In the example of FIG. 4, a UE 120 receives one or more transmissions from a network device 110, such as a base station, at time 402. The transmission may include multiple code blocks, transport blocks (TBs) or code block groups (CBGs). The UE 120 transmits HARQ feedback, via a HARQ-ACK payload, depending on whether the UE 120 successfully decodes the transmission, at time 402. It is noted that different ACK/NACK bits corresponding to the HARQ-ACK payload may correspond to different PDSCHs (scheduled at different slots/sub-slots or on different component carriers/serving cells), or may correspond to different TBs (each PDSCH may contain one or two TBs), or may correspond to different CBGs (each TB may contain multiple CBGs), or may correspond to different CBs (each TB or each CBG may contain multiple CBs).

In the example of FIG. 4, the UE 120 communicates a first HARQ-ACK part (e.g., first part of a HARQ-ACK codebook) to a network device 110, at time 404. In some examples, the first part may include a single bit indicating whether all HARQ feedback is ACK. In some such examples, the first part indicates that at least one bit of the multi-bit HARQ-ACK feedback is a NACK (e.g., first part bit=0), then the UE 120 transmits a second part HARQ-ACK to the network device 110, at time 406.

In the example of FIG. 4, the two HARQ-ACK parts may be separately encoded. In some examples, the network device 110 decodes the first HARQ-ACK part before decoding the second HARQ-ACK part. The first HARQ-ACK part may have a fixed size. Additionally, a size and interpretation of the second HARQ-ACK part may be a function of a codepoint of the first HARQ-ACK part.

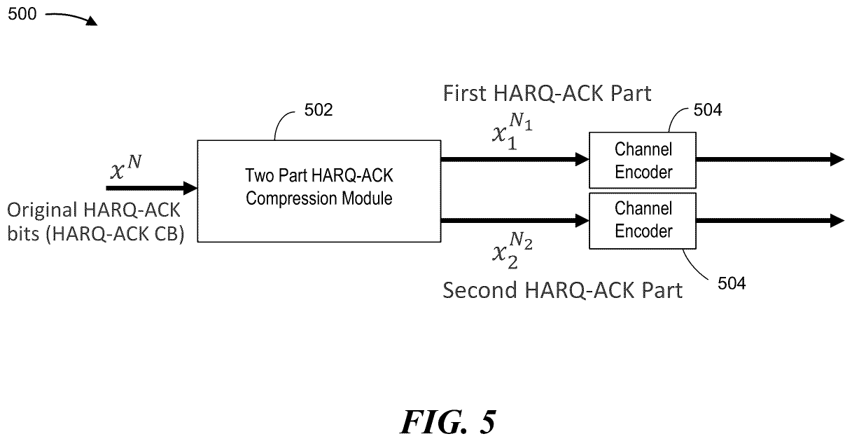

FIG. 5 is a block diagram illustrating an example 500 of forming two HARQ-ACK parts based on an initial HARQ-ACK payload, in accordance with various aspects of the present disclosure. In the example of FIG. 5, a transmitter, such as a UE, may generate an initial HARQ-ACK payload (e.g., original HARQ-ACK payload) in accordance with receiving a set of downlink transmissions from a network node. The UE may be an example of a UE 120 described with reference to FIGS. 1-4, and the network node may be an example of a base station 110 or network device 110 described with reference to FIGS. 1-4. In some examples, the UE may transmit, to the network node, a message indicating whether it supports forming two HARQ-ACK parts based on an original HARQ-ACK payload.

As shown in FIG. 5, the original HARQ-ACK codebook x^{N} (e.g., HARQ-ACK payload) may be processed by a two part HARQ-ACK compression module 502 to form the first HARQ-ACK part x₁^{N}^{₁} and the second HARQ-ACK part x₂^{N}^{₂}. Each HARQ-ACK part x₁^{N}^{₁} and x₂^{N}^{₂} may be separately encoded by a channel encoder 504 and then transmitted to a receiver, such as the network node. The channel encoders 504 may be the same or different channel encoders. In some examples, a size of an original HARQ-ACK codebook (CB) (e.g., initial HARQ-ACK codebook) may be N bits. The N bits may also be referred to as a HARQ-ACK payload size. In such examples, a size of the first HARQ-ACK part may be N₁ bits, and a size of the second HARQ-ACK part may be N₂ bits. In some examples, a first size N₁ is fixed. In some examples, the first size N₁ may be a function of a size N of the original HARQ-ACK payload. That is, the first size N₁ may be fixed for a given size N of the original HARQ-ACK payload. Additionally, a second size N₂ may be variable and may be a function of the first size N₁. The two part HARQ-ACK may provide error-free compressions. For example, given the first HARQ-ACK part x₁^{N}^{₁} and the second HARQ-ACK part x₂^{N}^{₂}, the receiver may determine the original HARQ-ACK codebook x^{N}. Specifically, the network node may decode the first HARQ-ACK part x₁^{N}^{₁}, determine a second size N₂ based on decoding the first HARQ-ACK part x₁^{N}^{₁} decode the second HARQ-ACK part x₂^{N}^{₂}, and then determine the original HARQ-ACK codebook x^{N} based on the first HARQ-ACK part x₁^{N}^{₁} and the second HARQ-ACK part x₂^{N}^{₂}.

In some examples, the first HARQ-ACK part x₁^{N}^{₁} and the second HARQ-ACK part x₂^{N}^{₂} may be determined based on a first fixed rule. In such examples, if the original HARQ-ACK codebook x^{N} is all ACKs (e.g., all N bits of the original HARQ-ACK codebook x^{N} are ACKs), the first HARQ-ACK part x₁^{N}^{₁} indicates one and the second HARQ-ACK part x₂^{N}^{₂} is empty. In this example, the first size N₁ is one and the second size N₂ is zero. Additionally, in such examples, if the original HARQ-ACK codebook x^{N} includes one or more NACKs, the first HARQ-ACK part x₁^{N}^{₁} indicates zero and the second HARQ-ACK part x₂^{N}^{₂} indicates the original HARQ-ACK codebook x^{N}, such that the second size N₂ is equal to a size N of the original HARQ-ACK codebook x^{N}. In these examples, the first HARQ-ACK part x₁^{N}^{₁} is a binary AND operation across all N bits of the original HARQ-ACK codebook x^{N}.

In other examples, the first HARQ-ACK part x₁^{N}^{₁} and the second HARQ-ACK part x₂^{N}^{₂} may be determined based on a second fixed rule. In such examples, if the original HARQ-ACK codebook x^{N} is all ACKs or all NACKs, the first HARQ-ACK part x₁^{N}^{₁} indicates one, the first size N₁ is one, and the second size N₂ is one. In such examples, if the original HARQ-ACK codebook x^{N} is all ACKs, the second HARQ-ACK part x₂^{N}^{₂} indicates one. Alternatively, if the original HARQ-ACK codebook x^{N} is all NACKs, the second HARQ-ACK part x₂^{N}^{₂} indicates zero. Additionally, in such examples, if the original HARQ-ACK codebook x^{N} includes one or more NACKs, the first HARQ-ACK part x₁^{N}^{₁} indicates zero and the second HARQ-ACK part x₂^{N}^{₂} indicates the original HARQ-ACK codebook x^{N}, such that the second size N₂ is equal to a size N of the original HARQ-ACK codebook x^{N}.

In some other examples, for each possible HARQ-ACK payload size N, the UE receives partitioning information from the network node. For example, the network node may transmit an RRC message indicating the partitioning information. Each possible HARQ-ACK payload size N may be associated with 2^{N} codepoints. For example, a payload size of two may be associated with four codepoints (00, 01, 10, and 11). In such examples, the network node may partition the 2^{N} codepoints into 2^{N}, groups, where each group g (1≤g≤2^{N}^{₁}) includes one or more members m_{g}. The parameter g represents a group index. The first HARQ-ACK part x₁^{N}^{₁} may have a fixed size and the second HARQ-ACK part x₂^{N}^{₂} may have a variable length based on a number of members m_{g} in a group g. For example, a second size N₂ of the second HARQ-ACK part x₂^{N}^{₂} may be equal to [log₂ m_{g}] bits.

In some examples, for each payload size N, the network node transmits a message indicating a group index g for each codepoint of the set of 2^{N} codepoints. For example, if the payload size N is five, there may be thirty-two codepoints (2⁵). For ease of explanation, the first size N₁ may equal two, such that there are four groups (2²). In this example, the network node indicates a group index g for each of the thirty-two codepoints. For example, the network node may indicate that codepoint 11111 is associated with group one, codepoints 11110 and 111101 are associated with group two, codepoints 11011 to 11100 are associated with group three, and codepoints 11010 to 00000 are associated with group four. In this example, the first HARQ-ACK part x₁^{N}^{₁} may indicate 00 for group one, 01 for group two, 10 for group three, and 11 for group four. The second size N₂ of the second HARQ-ACK part x₂^{N}^{₂} may be equal to [log₂ m_{g}] bits. For example, for group one, the second size N₂ may be zero because group one only has one member (e.g., [log₂ 1]=0). As another example, for group two, the second size N₂ may be one because group two has two members (e.g., [log₂ 2]=1). In this example, the second HARQ-ACK part x₂^{N}^{₂} may indicate zero to indicate a first member (11110) of group two and one to indicate a second member (11101) of group two. Aspects of the present disclosure are not limited to the aforementioned example, other codepoint values may be associated with each group index g. In some such examples, a value of the first size N₁ or the number of groups 2^{N}^{₁} may be pre-defined. In other examples, a value of the first size N₁ or the number of groups 2^{N}^{₁} may be based on one or more possible values based on the payload size N.

In some other examples, for each payload size N, the network node transmits a message indicating 2^{N}^{₁} lists, where each list corresponds to a group index g and includes the respective members m_{g} (e.g., codepoints) associated with the group index g. For example, if the payload size N is five, there may be thirty-two codepoints (2⁵). For ease of explanation, N₁ may equal two, such that there are four groups (2²). In this example, the network node indicates four lists. For example, a first list indicates that group one includes codepoint 11111, a second list indicates that group two includes codepoints 11110 and 111101, a third list indicates that group three includes codepoints 11011 to 11100, and a fourth list indicates that group four includes codepoints 11010 to 00000. In this example, the first list includes one member, the second list includes two members, the third list includes four members, and the fourth list includes twenty-five members. As an example, if the codepoint (e.g., HARQ-ACK payload) is 11010, the first HARQ-ACK part x₁^{N}^{₁} indicates 11 corresponding to group four and the second HARQ-ACK part x₂^{N}^{₂} may indicate 00000 corresponding to the first member of the fourth group. Aspects of the present disclosure are not limited to the aforementioned example, other codepoint values may be associated with the lists. Additionally, the number of lists may be equal to or less than the number of groups. For example, the network node may indicate lists associated with three of the four groups, and the UE may deduce the members of the fourth group. In some such examples, a value of the first size N₁ or the number of groups 2^{N}^{₁} may be pre-defined. In other examples, a value of the first size N₁ or the number of groups 2^{N}^{₁}, may be based on one or more possible values based on the payload size N.

In some other examples, both the UE and the network node assume a same ordering across the 2^{N} codepoints. For example, the ordering may be based on an ordering described in TABLE 1. For each payload size N, the network node transmits a message indicating a number of members m_{g} for each of the 2^{N}^{₁}−1 groups. The number of members m_{g} may be indicated by a parameter p_{g}, in which p_{g}=log₂ m_{g} assuming that the number of members m_{g} in all groups (expect the last group) is a power of two (i.e., m_{g}=2^{P}^{_{g}}). In such examples, the UE may deduce the members of a group that is not included in the 2^{N}^{₁}−1 groups, based on the members m_{g} of each of the 2^{N}^{₁}−1 groups. As an example, based on the example of TABLE 1, if the payload size N is five, there may be thirty-two codepoints (2⁵). For ease of explanation, N₁ may equal two, such that there are four groups (2²). In this example, the network node indicates group one includes one member, group two includes two members, and group three includes four members. Alternatively, the network node may indicate 2^{N}^{₁}−1 values corresponding to the last member in the ordered list for the first 2^{N}^{₁}−1 groups. For example, based on TABLE 1, the network node may indicate 11111 corresponding to the last member of group one, 11101 corresponding to the last member of group two, and 11100 corresponding to the last member of group three. As another alternative, the network node may indicate a first member in the ordered list (TABLE 1) for the last 2^{N}^{₁}−1 groups. For example, based on TABLE 1, the network node may indicate 11110 corresponding to the first member of group two, 11011 corresponding to the first member of group three, and 11010 corresponding to the first member of group four. In some such examples, a value of the first size N₁ or the number of groups 2^{N}^{₁}−1 may be pre-defined. In other examples, a value of the first size N₁ or the number of groups 2^{N}^{₁}−1 may be based on one or more possible values based on the payload size N.

TABLE 1

| x^{N} | p(x^{N}) | g/x₁^{N}^{₁} | x₂^{N}^{₂} | N₁ + N₂ |
|---|---|---|---|---|
| 11111 | 0.59049 | 1/00 | Ø | 2 |
| 11110 | 0.06561 | 2/01 | 0 | 3 |
| 11101 | 0.06561 | 2/01 | 1 | 3 |
| 11011 | 0.06561 | 3/10 | 00 | 4 |
| 10111 | 0.06561 | 3/10 | 01 | 4 |
| 01111 | 0.06561 | 3/10 | 10 | 4 |
| 11100 | 0.00729 | 3/10 | 11 | 4 |
| 11010 | 0.00729 | 4/11 | 00000 | 7 |
| 11011 | 0.00729 | 4/11 | 00001 | 7 |
| . . . | . . . | . . . | . . . | . . . |
| 00000 | 1e−05 | 4/11 | 11000 | 7 |

In some examples, the values in the ordered list (e.g., TABLE 1) may be based on a probability of occurrence for the 2^{N} codepoints. In other examples, to ensure both UE and network node assume the same ordering, the 2^{N} codepoints may be ordered based on the number of ACKS (“1”) in each codepoint. Codepoints having a same number of ACKS may be ordered based on a decimal representation of the binary sequence corresponding to the respective codepoints.

In other examples, for each payload size N, the network node may indicate the first size N₁ or a number of groups 2^{N}^{₁} for a given codepoint. In such examples, the partitioning may be based on a rule associated with a value of the first size N₁. Additionally, in such examples, both the UE and the network node assume a same ordering across the 2^{N} codepoints, such as the ordering in TABLE 1. In some implementations, if a value of the first size N₁ is one, group one includes a first codepoint (e.g., 11111) and the second group includes the remaining 2^{N}−1 members. Alternatively, if a value of the first size N₁ is two, group one includes the first codepoint (e.g., 11111), group two includes the next two codepoints (e.g., 11110 and 11101), group three includes the next four codepoints, the fourth group includes the remaining codepoints. In general, the i'th group includes 2ⁱ⁻¹ members, and the last group of the 2^{N}^{₁} groups includes the remaining groups (e.g.,

$${2}^{N} - {\sum }_{i = 1}^{{2}^{{N}_{1}} - 1} {2}^{i - 1} = {2}^{N} - ( {2}^{( {2}^{{N}_{1}} - 1 )} - 1 ) .$$

In some such examples, a value of the first size N₁ or the number of groups 2^{N}^{₁} may be based on one or more possible values based on the payload size N.

In some examples, if a group of partition schemes is specified, such as two or more of the partitioning schemes discussed above, the network node may enable one of the partitioning schemes via control signaling, such as an RRC message. Additionally, or alternatively, the UE may indicate support for one or more partitioning schemes via UE capability signaling.

In some examples, the UE may receive, from the network node, a message enabling the UE to form the first HARQ-ACK part and the second HARQ-ACK part. In such examples, the message is one of a radio resource control (RRC) message, a medium access control (MAC)-control element (CE) message, or downlink control information (DCI). The RRC message may semi-statically enable the UE to form the first HARQ-ACK part and the second HARQ-ACK part per PUCCH group. The MAC-CE message may enable the UE to form the HARQ-ACK parts, for a given PUCCH group, and UE forms each HARQ-ACK part after a MAC-CE application time (e.g., 3 ms after a HARQ-ACK associated with the PDSCH that carries the MAC-CE message).

The DCI may be a downlink DCI that schedules a PDSCH or indicates a PUCCH resource for HARQ-ACK transmission. Alternatively, the DCI may be an uplink DCI that schedules a PUSCH. In other examples, the DCI may be a group-common DCI format. The DCI may include a field, such as a one-bit field, that indicates whether to for the two HARQ-ACK parts. The presence of the field may be RRC-configured per DCI format. For example, among DCI formats 1_1/1_2/0_1/0_2, some DCI formats may be configured to include this field, while other DCI formats may not include this field.

As discussed, various parameters for the various aspects of the present disclosure may be RRC configuration. In some examples, one or more parameters may be indicated by a MAC-CE message or DCI. For example, the choice between the first size N₁ have a value of one (1-bit first HARQ-ACK part) or a value of two (2-bits first HARQ-ACK part) may be dynamically indicated by the MAC-CE message or DCI. Additionally, the various parameters described for the various aspects of the present disclosure may be configured per physical layer priority.

As discussed, in some cases, when using a fixed partitioning scheme, a compression ratio for a HARQ-ACK payload may decrease as a size N of the HARQ-ACK payload increases. Various aspects of the present disclosure are directed to increasing a HARQ-ACK payload compression ratio while using a fixed partitioning scheme for larger HARQ-ACK payload sizes N, such as a HARQ-ACK payload with a size N that is greater than a size threshold. In some examples, the HARQ-ACK payload may be segmented into a group of segments (e.g., blocks) prior to forming a first HARQ-ACK part and a second HARQ-ACK part.

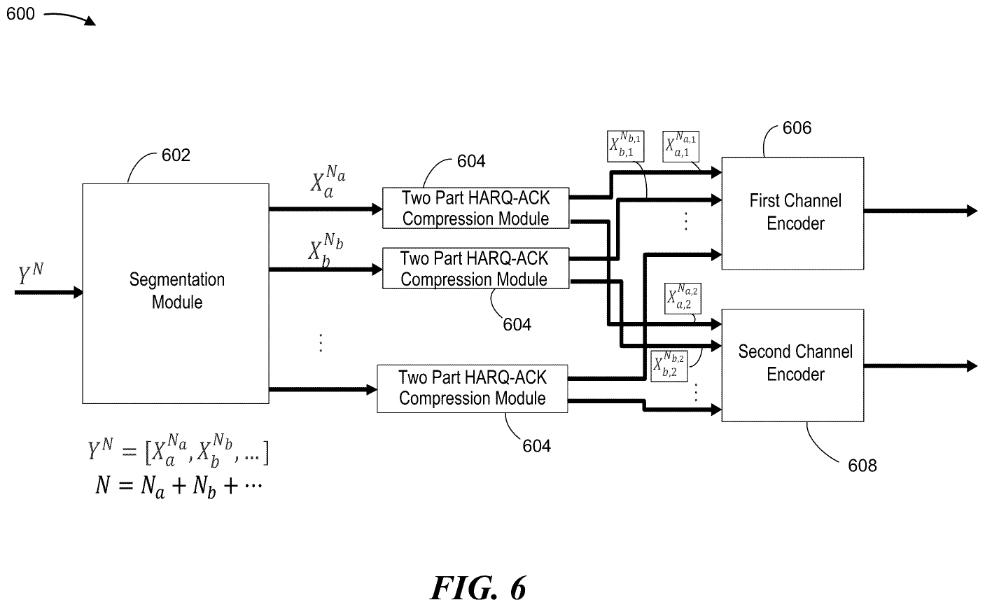

FIG. 6 is a block diagram illustrating an example 600 of forming two HARQ-ACK parts based on a group of HARQ-ACK payload segments, in accordance with various aspects of the present disclosure. In the example of FIG. 5, a transmitter, such as a UE, may generate an original HARQ-ACK payload Y^{N} (e.g., original HARQ-ACK codebook (CB)) in accordance with receiving a set of downlink transmissions from a network node. As shown in the example 600, an original HARQ-ACK payload. The UE may be an example of a UE 120 described with reference to FIGS. 1-4, and the network node may be an example of a base station 110 or network device 110 described with reference to FIGS. 1-4.

The original HARQ-ACK payload Y^{N} may be received at a segmentation module 602, such that the original HARQ-ACK payload Y^{N}, having a size N, may be segmented into M segments with respective lengths Nₐ, N_{b}, . . . N_{M}, such that N=Nₐ+N_{b}+ . . . N_{M} and Y^{N}=[Xₐ^{N}^{ₐ}, X_{b}^{N}^{_{b}}, . . . , X_{M}^{N}^{_{M}}]. The lengths Nₐ, N_{b}, . . . N_{M} may be uniform or two or more lengths Nₐ, N_{b}, . . . N_{M} may be different. For ease of explanation, only segments Xₐ^{N}^{ₐ} and X_{b}^{N}^{_{b}} are shown in the example 600. The segmentation module 602 may segment the original HARQ-ACK payload Y^{N} based on a configuration received from the network node and/or one or more rules.

In some examples, the original HARQ-ACK payload Y^{N} may be segmented if the payload size N is greater than a first payload size threshold, such as 5 or 6 bits. In such examples, the UE may consider the original HARQ-ACK payload Y^{N} as a single block and convert the single block into two HARQ-ACK parts, as discussed above with reference to FIG. 5, if the payload size N is less than a first payload size threshold and greater than a second payload size threshold. The network node may transmit an RRC message that dynamically indicates the first and/or second payload size thresholds. Alternatively, the first and/or second payload size thresholds may be statically configured. In some examples, if the payload size N is less than the second payload size threshold (which is less than the first payload size threshold), the UE does not transform the original HARQ-ACK payload Y^{N} into two HARQ-ACK parts and the original HARQ-ACK payload Y^{N} may be encoded as a single block. In some examples, the second payload size threshold is 2 or 3 bits.

In some examples, each segment is a contiguous segment of bits from the original HARQ-ACK payload Y^{N}. In such examples, a nominal block size L may be configured via RRC signaling or may be pre-configured at the UE. A total number of segments may be based on the nominal block size L and the payload size N. A value of the nominal block size L may be based on the payload size N or may be independent of the payload size N. In some such examples, if a quotient of the payload size N divided by the nominal block size L (e.g., N/L) is an integer, the segmentation module 602 generates (N/L) segments, where each segment has a length equal to the nominal block size L. Otherwise, if the quotient is a non-integer, in some examples, the segmentation module 602 generates Mod(N,L) segments of length L and [floor (N/L)−Mod(N,L)] segments of length to L+1. The floor function (floor( )) returns the greatest integer that is less than or equal to an input of the floor function. In other examples, if the quotient is a non-integer, the segmentation module 602 generates floor (N/L) segments of length L and one segment of length Mod(N,L).

In some examples, a quantity of segments M may be based on a fixed value or an RRC message configuring the quantity of segments M. In such examples, a length of each segment may be based on the quantity of segments M and the payload size N. The quantity of segments M may be independent of the payload size N or may be based on the payload size N. In some examples, the network node may configure different values for the quantity of segments M for different payload sizes N. In some such examples, if a quotient of the payload size N divided by quantity of segments M (e.g., N/M) is an integer, the segmentation module 602 generates M segments, where each segment has a length equal to the quotient (N/M). Otherwise, if the quotient is a non-integer, in some examples, the segmentation module 602 generates Mod(N,M) segments of length ceil(N/M) and M−Mod(N,L) segments of length floor (N/M). The ceiling function (ceil( )) returns the greatest integer that is greater than or equal to an input of the ceiling function. In some other examples, if the quotient is a non-integer, the segmentation module 602 generates M−1 segments of length ceil(N/M) and one segment of length Mod(N, ceil(N/M)).

In other examples, for a given payload size N, a length of each block may be configured via an RRC message. For example, the RRC message may include a vector, with each element of the vector indicating a length of a specific segment of the group of segments Xₐ^{N}^{ₐ}, X_{b}^{N}^{_{b}}, . . . , X_{M}^{N}^{_{M}}. In such examples, a length of a last segment may be determined as: N−(Nₐ, N_{b}, . . . N_{M-1}). This vector may be pre-configured for each payload size N, and the UE uses a corresponding configuration in accordance with a given size N of the HARQ-ACK payload.

In some other examples, each segment may be based on ACK/NACK bits of the HARQ-ACK payload corresponding to one or more of a same component carrier, a same physical downlink shared channel (PDSCH), or a same state in a time domain (for example, PDSCHs received in a given duplex type, such as full-duplex or half-duplex). In such examples, the bits of each segment may not be contiguous bits of the original HARQ-ACK payload. In some such examples, each segment may be based on different code blocks (CBs), different code block groups (CBGs), or different transport blocks (TBs) of a same PDSCH.

The UE may form, for each segment of the group of segments Xₐ^{N}^{ₐ}, X_{b}^{N}^{_{b}}, . . . , X_{M}^{N}^{_{M}}, a two part HARQ-ACK compression module 604, a first HARQ-ACK part and a second HARQ-ACK part. The two parts may be formed separately and independently for each segment. A size of the second HARQ-ACK part may be a function of the first HARQ-ACK part. Thus, as shown in the example 600, the UE may generate a set of first HARQ-ACK parts and a set of second HARQ-ACK parts by forming a respective first HARQ-ACK part and a respective second HARQ-ACK part for each one of the group of segments Xₐ^{N}^{ₐ}, X_{b}^{N}^{_{b}}, . . . , X_{M}^{N}^{_{M}}. As shown in FIG. 6, a first channel encoder 606 may jointly encode the set of first HARQ-ACK parts and a second channel encoder 608 may jointly encode the set of second HARQ-ACK parts. The first channel encoder 606 and the second channel encoder 608 may be the same or different channel encoders. The UE may transmit the jointly encoded first HARQ-ACK parts and the jointly encoded second HARQ-ACK parts to the network node.

In some examples, a segment may not be transformed into the two part HARQ-ACK if a size of the segment is less than a segment size threshold. As an example, the segment size threshold may be one or two bits. In such examples, the segment may be considered a first HARQ-ACK part and may be encoded with other first HARQ-ACK parts via the first channel encoder 606.

For each segment, a size of the first HARQ-ACK part may be fixed. In some examples, the size of the first HARQ-ACK part may not be a function of a payload of the segment. However, the size of the first HARQ-ACK part may be a function of a size of the segment. Additionally, for each segment, the size of the second HARQ-ACK part may vary based on a payload of the segment and/or a payload of the first HARQ-ACK part.

In some examples, the two HARQ-ACK parts may be formed in accordance with a first partitioning scheme, in which one bit is allocated to the first HARQ-ACK part. In one example, for the first partitioning scheme, the first HARQ-ACK part may indicate a value of one if the original HARQ-ACK payload is all ACKs. In this example, the second HARQ-ACK part is empty. In another example, the first HARQ-ACK part may indicate a value of zero if the original HARQ-ACK payload includes one or more NACKs. In this example, the second HARQ-ACK part includes the payload of the segment (Nₓ bits).

In other examples, the two HARQ-ACK parts may be formed in accordance with a second partitioning scheme, in which two bits are allocated to the first HARQ-ACK part. In such examples, the codepoints associated with the original HARQ-ACK payload are grouped into four groups, such as the groups described with reference to TABLE 1. For example, a first group includes one codepoint, a second group includes two codepoints, a third group includes four codepoints, and a fourth group includes remaining codepoints (e.g., 2^{N}^{ₓ}−7 codepoints). The codepoints may be sorted in accordance with a pre-defined order. In such examples, the first HARQ-ACK part indicates a group associated with a payload. Additionally, a size of the second HARQ-ACK part may be one of the following: empty if the first HARQ-ACK part indicates the first group, one bit if the first HARQ-ACK part indicates the second group, two bits if the first HARQ-ACK part indicates the third group, and log₂(2^{N}−7) bits if the first HARQ-ACK part indicates the fourth group. In such examples, the UE may receive, from the network node, signaling that associates codepoints with respective groups. The second partitioning scheme may not be limited to a fixed number of groups, such as four groups. In some examples, the number of groups may be configured by the network node via signaling, such as RRC signaling, and for each segment length Nₓ.

In some examples, the two part HARQ-ACK compression module 604 may use the first partitioning scheme or the second partitioning scheme in accordance with RRC signaling received from the network node. Additionally, or alternatively, the first partitioning scheme or the second partitioning scheme may be selected in accordance with a length Nₓ of a segment. For example, the first partitioning scheme may be used if the segment length Nₓ is less than a length threshold, and the second partitioning scheme may be used if the segment length Nₓ is greater than or equal to the length threshold. The length threshold may be based on a fixed rule (e.g., first partitioning scheme for 2≤Nₓ<5, and second partitioning scheme for 5≤Nₓ). Alternatively, RRC signaling, from a network node, may explicitly identify a partitioning scheme to use for each segment length Nₓ.

As discussed, in some examples, the first HARQ-ACK part and the second HARQ-ACK part may be multiplexed onto a same channel. The first HARQ-ACK part and the second HARQ-ACK part may be referred to as uplink control information (UCI). For example, the first HARQ-ACK part and the second HARQ-ACK part may be multiplexed on a same physical uplink shared channel (PUSCH) when a physical uplink control channel (PUCCH) associated with an original HARQ-ACK payload overlaps the PUSCH associated with the multiplexed UCI. In some examples, a UE or network node may only support multiplexing the first HARQ-ACK part and the second HARQ-ACK part on the same PUSCH. In such examples, if the PUCCH does not overlap with any PUSCH, the original HARQ-ACK payload may be transmitted directly on the PUCCH without transforming the original HARQ-ACK payload into two parts. Alternatively, the original HARQ-ACK payload may be transformed, and only the first HARQ-ACK part is transmitted. That is, the second HARQ-ACK part may be omitted (e.g., in response to the PUCCH not overlapping with a PUSCH). In other examples, if the PUCCH overlaps the PUSCH, the UE multiplexes both HARQ-ACK parts on the PUSCH, rather than transmitting the original HARQ-ACK payload. In other examples, if the PUSCH is scheduled by DCI, the DCI may indicate whether the two part HARQ-ACK should be multiplexed on the PUSCH or whether the original HARQ-ACK payload should be multiplexed on the PUSCH.

In some examples, the first HARQ-ACK part and the second HARQ-ACK part may be multiplexed in accordance with a puncturing scheme or a rate matching scheme. As an example, the first HARQ-ACK part may puncture PUSCH data resource elements (REs), particularly when the first HARQ-ACK part is one bit or two bits. For example, the first HARQ-ACK part punctures PUSCH data REs that would otherwise carry the coded bits corresponding to the UL TB. The first HARQ-ACK part may not puncture PUSCH data REs if the first HARQ-ACK part is jointly encoded with other UCI. Depending on a size of the second HARQ-ACK part, the second HARQ-ACK part may either puncture PUSCH data REs or undergo rate matching. That is, coded bits corresponding to the UL TB, that is carried on the PUSCH, may be rate matched around the REs that carry the coded bits of the UCI (e.g., second HARQ-ACK part). Specifically, the UE first determines REs that include the UCI (Part2 HARQ-ACK here), then the UE rate matches the coded bits of the UL TB around the REs that include the UCI (skipping the REs that include the UCI for the purpose of rate matching the UL TB). In some examples, the rate matching scheme for the second HARQ-ACK part may be performed if it satisfies a rate matching condition. For example, the rate matching condition may be satisfied if the second HARQ-ACK part size is greater than a threshold (otherwise, the puncturing scheme is performed). As another example, the rate matching condition may be satisfied if the second HARQ-ACK part size is less than a threshold (otherwise, the puncturing scheme is performed). In other examples, the rate matching scheme for the second HARQ-ACK part may be performed irrespective of its size.

In some examples, other UCI, such as a configured grant (CG)-UCI (CG-UCI) or channel state information (CSI), may also be transmitted on the PUSCH. In some such examples, the CG-UCI may be jointly encoded with either the first HARQ-ACK part or the second HARQ-ACK part. In another example, if the CSI only has one part, the CSI may be separately encoded and then multiplexed onto the PUSCH, resulting in the multiplexing of three distinct UCI messages (e.g., the CSI, the first HARQ-ACK part, and the second HARQ-ACK part). Multiplexing of the three distinct UCI messages may also follow a specific order such as first multiplex the first HARQ-ACK part, second multiplex the second HARQ-ACK part, and third multiplex the CSI. This order is not limited to multiplexing the first HARQ-ACK part, the second HARQ-ACK part, and the CSI, a specific order for multiplexing may be used for other examples of multiplexing one or more UCI messages (e.g., the first HARQ-ACK part, the second HARQ-ACK part, and/or other UCI) on an uplink channel, such as a PUSCH.

In some examples, the CSI may have two parts, in which both part-one CSI and part-two CSI are separately encoded. Current wireless standards only allow up to three different UCI types to be multiplexed on the PUSCH. Therefore, various strategies may be used to multiplex a two-part CSI with both HARQ-ACK parts.

In some examples, the part-two CSI may be ignored, such that only the first HARQ-ACK part, the second HARQ-ACK part, and part-one CSI are multiplexed on the PUSCH. In other examples, both HARQ-ACK parts and both CSI parts are separately encoded and multiplexed on the same PUSCH. That is, four distinct UCI messages are multiplexed on the PUSCH. In other examples, the first HARQ-ACK part may be encoded with the part-one CSI, and the second HARQ-ACK part may be encoded with the part-two CSI. This results in two distinct encoded UCI messages being multiplexed on the PUSCH. Alternatively, other examples may use a hybrid approach, in which the first HARQ-ACK part may be jointly encoded with the part-one CSI and subsequently multiplexed with the individual encodings of the second HARQ-ACK part and the part-two CSI, which results in three distinct UCI messages to be multiplexed on the PUSCH.

In other examples, the second HARQ-ACK part may be jointly encoded with the part-two CSI. This joint encoding may be multiplexed on the PUSCH with the individual encodings of the first HARQ-ACK part and the part-one CSI, which results in three distinct UCI messages to be multiplexed on the PUSCH. In still other examples, the second HARQ-ACK part may be jointly encoded with the part-one CSI, after which the individual encodings of the first HARQ-ACK part and the part-two CSI may be multiplexed with the joint encoding of the second HARQ-ACK part with part-one CSI on the PUSCH, which results in three distinct UCI messages to be multiplexed on the PUSCH.

Other examples may simplify the process, such that, rather than splitting the HARQ-ACK into two parts, the entire HARQ-ACK payload is transmitted and then multiplexed alongside the part-one and part-two CSI on the PUSCH, which results in three distinct UCI messages to be multiplexed on the PUSCH. In this example, refraining from transforming the original HARQ-ACK payload into two part HARQ-ack is in response to the presence of two part CSI on the same PUSCH. Lastly, in other examples, the transmission of the second HARQ-ACK part and/or the second CSI part may be delayed, making it possible to shift the delayed transmission to a subsequent PUCCH/PUSCH transmission scenario.

In some examples, a PUCCH (e.g., PUCCH resource) designated for transmitting an original HARQ-ACK payload may not overlap with a PUSCH (e.g., PUSCH resource). In such examples, the first HARQ-ACK part may be transmitted on the PUCCH, while the second HARQ-ACK part may be multiplexed onto a PUSCH, such as a subsequent PUSCH. This multiplexing scheme may present complexities when there is a delay in transmitting the second HARQ-ACK part, particularly if there is no overlap between the PUCCH and a PUSCH. Various aspects of the present disclosure are directed to selecting an appropriate PUSCH for the second HARQ-ACK part.

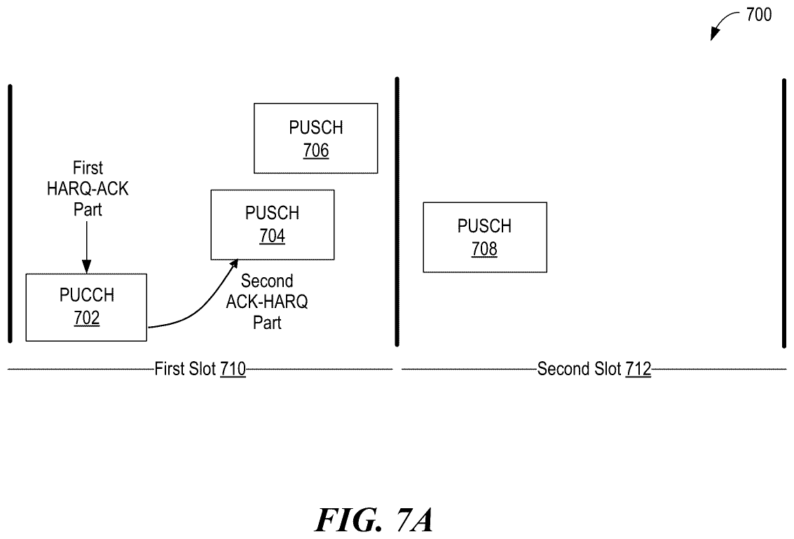

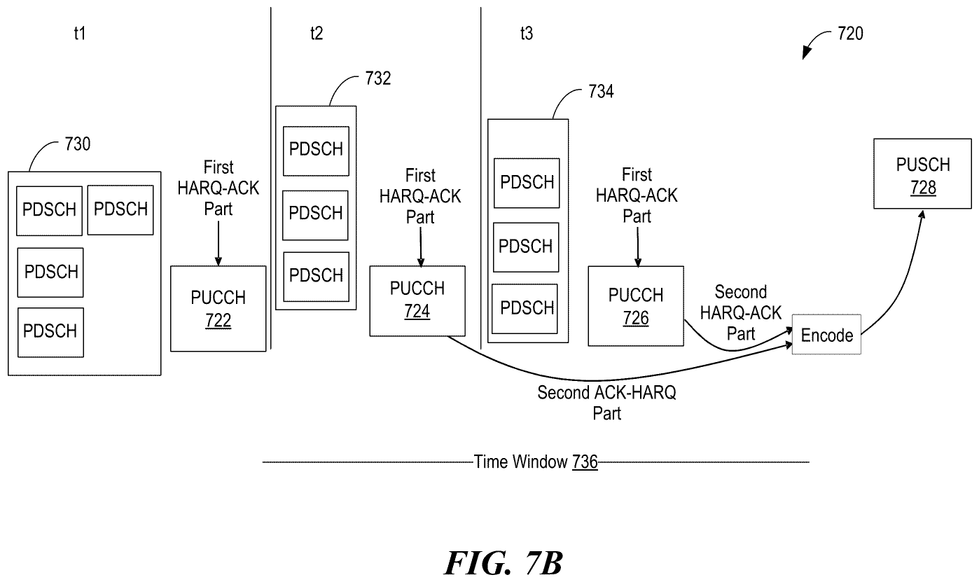

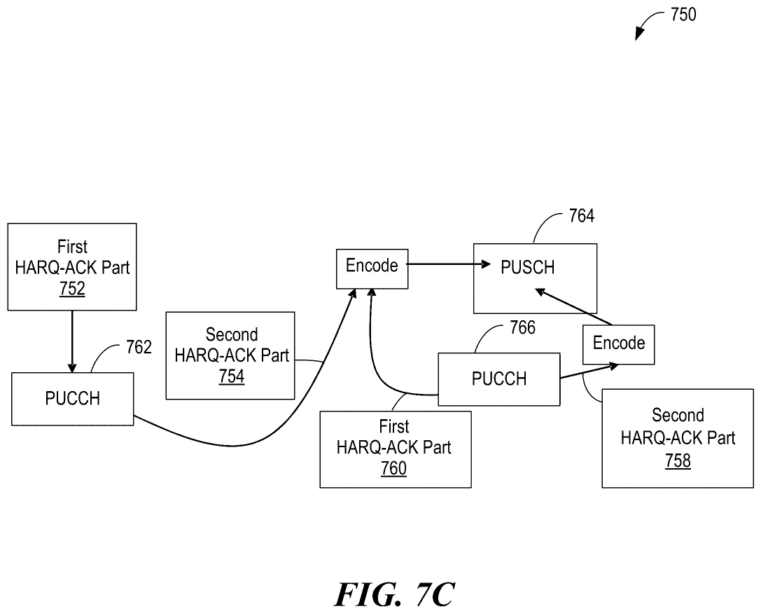

FIG. 7A is a block diagram illustrating an example 700 of selecting a PUSCH for a second HARQ-ACK part, in accordance with various aspects of the present disclosure. In the example 700 of FIG. 7A, the PUCCH 702 may be associated with a first HARQ-ACK part. Additionally, the second HARQ-ACK part may be associated with one of the groups of subsequent PUSCHs 704, 706, and 708.

In some examples, when the first HARQ-ACK part is allocated to the PUCCH 702, the user equipment (UE) selected the first PUSCH 704 having an earliest start symbol after the PUCCH 702. When encountering multiple candidate PUSCHs with a same start symbol across different component carriers (CCs) (not shown in the example of FIG. 7A), the UE prioritizes the PUSCH with the lowest CC index. However, if this earliest PUSCH is not scheduled within a subsequent number of slots from the PUCCH slot, such as S slots (inclusive of a first slot 710), the second HARQ-ACK part may be discarded. A value of the number of slots S may be a preset value, such as one or two, or the value may be configured by the network node via signaling, such as radio resource control (RRC) signaling.

In some other examples, the UE may identify PUSCH candidates 704, 706, 708 within the next S slots from the PUCCH slot (inclusive of the PUCCH slot (e.g., first slot 710)). Out of these PUSCH candidates 704, 706, 708, the UE may select a PUSCH based on a priority order. In some examples, the priority order may prioritize PUSCHs with aperiodic CSI, then dynamic grant PUSCH over configured grant PUSCH, followed by the smallest CC index, and finally the PUSCH with an earlier starting time within the same CC. In such examples, if a PUSCH is not scheduled within the stipulated S slots, the second HARQ-ACK part may be discarded. As discussed, a value of the number of slots S may be a preset value, such as one or two, or the value may be configured by the network node via signaling, such as radio resource control (RRC) signaling.

In some examples, a timeline (T_{proc}) may be defined in relation to a first symbol (S₀) of the earliest PUSCH 704. In such examples, the first symbol should not precede a symbol beyond the timeline following a last symbol of any physical downlink control channel (PDCCH) associated with a DCI that schedules a prospective PUSCH. This rule may apply to selecting the PUSCH with the earlier start symbol or selecting a PUSCH from candidate PUSCHs within S slots.

In some other examples, a specific bit in the uplink (UL) DCI, such as DCI 0_1 or DCI 0_2, that schedules a PUSCH may indicate whether to multiplex a pending second HARQ-ACK part. When a group of second HARQ-ACK parts have been scheduled, the DCI may indicate one or more second HARQ-ACK part from the group of second HARQ-ACK parts. The second HARQ-ACK parts may be multiplexed on the one or more PUSCHs. The group of second HARQ-ACK parts may originate from different PUCCH resources in distinct slots corresponding to different original HARQ-ACK payloads.

As discussed, in some examples, a group of second HARQ-ACK parts may be pending. In some such examples, a respective first HARQ-ACK part corresponding to each of the group of second HARQ-ACK parts may have been transmitted on a corresponding PUCCH. In some examples, the UE may jointly encode all pending second HARQ-ACK parts. The jointly encoded second HARQ-ACK parts may then be multiplexed onto the next PUSCH.

In other examples, the UE may only retain a most recent second HARQ-ACK part for multiplexing on the subsequent PUSCH. When determining the most recent second HARQ-ACK part, the UE may only consider non-zero sized second HARQ-ACK parts. For example, if the first HARQ-ACK part indicates the HARQ-ACK payload is all ACKs, the second HARQ-ACK part is empty (e.g., the size is zero). In some examples, second HARQ-ACK parts with a given priority level or higher may be considered when selecting the most recent second HARQ-ACK part.

FIG. 7B is a block diagram illustrating an example 720 of a group of pending second HARQ-ACK parts, in accordance with various aspects of the present disclosure. In the example 720 of FIG. 7B, a UE may receive a group of PDSCH transmissions 730, 732, 734 at each time instance t1, t2, and t3. A PUCCH 722, 724, 726 may be scheduled in response to receiving each group of PDSCH transmissions 730, 732, 734. Each PUCCH 722, 724, 726 may be associated with a HARQ-ACK payload, and the respective HARQ-ACK payloads may be transformed into a two part HARQ-ACK payload. For example, as shown in FIG. 7B, a first HARQ-ACK part may be formed at each time t1, t2, and t3. A corresponding second HARQ-ACK part may also be formed. In some examples, the UE may only select a subset of all pending second HARQ-ACK parts. For example, as shown in the example 720, the UE may only select the second HARQ-ACK parts at times t2 and t3. These second HARQ-ACK parts may be jointly encoded and multiplexed on a PUSCH 728.

In some examples, the subset of all pending second HARQ-ACK parts may be a number X of the most recent second HARQ-ACK parts. As discussed, the most recent second HARQ-ACK parts may be non-zero sized. Additionally, or alternatively, a priority of each second HARQ-ACK part may be used to select the X most recent second HARQ-ACK parts. In other examples, the number X may be configured by the network node via control signaling, such as RRC signaling, and/or in accordance with UE capability signaling.

In other examples, a time window 736 may be specified. The time window 736 may be configured via RRC signaling and/or in accordance with UE capability signaling. During the time window, all pending second HARQ-ACK parts may be multiplexed onto the PUSCH 728. The second HARQ-ACK parts that fall outside this time window 736 may be omitted. The time window 736 may be defined by a number of slots leading up to a slot associated with the subsequent PUSCH 728.

In some cases, a subsequent PUSCH may include a second original HARQ-ACK payload or a part associated with a second original HARQ-ACK payload due to another PUCCH overlapping with the PUSCH. In such cases, different multiplexing schemes may be used based on whether the second original HARQ-ACK payload has been transformed into one part or two parts.

In some examples, if the second HARQ-ACK payload has only been transformed into a first HARQ-ACK part (e.g., has not been transformed into a two part HARQ-ACK), the UE may jointly encode a second HARQ-ACK part associated with a first HARQ-ACK payload with the second HARQ-ACK payload, and multiplex the jointly encoded second HARQ-ACK part and second HARQ-ACK payload on the subsequent PUSCH. In other examples, if the second HARQ-ACK payload has only been transformed in a first HARQ-ACK part (e.g., has not been transformed into a two part HARQ-ACK), both the second HARQ-ACK part and the second HARQ-ACK payload are encoded separately. Subsequently, the UE multiplexes the second HARQ-ACK part and the second HARQ-ACK payload on the subsequent PUSCH.

In some cases, the second HARQ-ACK payload may be transformed into a first HARQ-ACK part and a second HARQ-ACK part. FIG. 7C is a block diagram illustrating an example 750 of multiplexing HARQ-ACK parts from different HARQ-ACK payloads, in accordance with various aspects of the present disclosure. In some examples, such as the example 750, a second HARQ-ACK part 754 associated with a first HARQ-ACK payload may be jointly encoded with a first HARQ-ACK part 760 associated with a second HARQ-ACK payload. A first HARQ-ACK part 752 associated with the first HARQ-ACK payload may be multiplexed on a first PUCCH 762. Additionally, the UE may separately encode a second HARQ-ACK part 758 associated with the second HARQ-ACK payload. The second HARQ-ACK payload may be associated with a second PUCCH 766. The jointly encoded first HARQ-ACK part 760 and second HARQ-ACK part 754 may be multiplexed with the second HARQ-ACK part 758 on the PUSCH 764. In the example 750, the second HARQ-ACK part 758 and the first HARQ-ACK part 760 associated with the second HARQ-ACK payload are separately encoded based on a size of the second HARQ-ACK part 758 being a function of the first HARQ-ACK part 760.

In other examples (not shown in FIG. 7C), the UE encodes the second HARQ-ACK part 754 associated with the first HARQ-ACK payload with the second HARQ-ACK part 758 associated with the second HARQ-ACK payload. The first HARQ-ACK part 760 associated with the second HARQ-ACK payload may be separately encoded. The jointly encoded HARQ-ACK parts 754 and 758, and the encoded HARQ-ACK part 760 may be multiplexed on the subsequent PUSCH 764.

In the aspects described with reference to FIG. 7C, two distinctly encoded UCI messages may be multiplexed on a PUSCH. In some other examples, as discussed, a second HARQ-ACK part associated with a first HARQ-ACK payload and a second HARQ-ACK payload may be separately encoded and then multiplexed on the PUSCH. Such examples also describe a scenario of multiplexing two distinctly encoded UCI messages on the PUSCH. The distinctly encoded UCI may be referred to as UCI1 HARQ-ACK and UCI2 HARQ-ACK. As previously discussed, three separately encoded UCI types may be multiplexed on the PUSCH.

In some cases, CG-UCI may be either jointly encoded with UCI1 HARQ-ACK or with UCI2 HARQ-ACK, and then multiplexed on the PUSCH. If CSI consists of one part, the CSI is separately encoded and multiplexed on the PUSCH, leading to three distinctly encoded UCI messages being multiplexed. However, different multiplexing schemes may be used if the CSI includes two parts (part-one CSI and part-two CSI). In some examples, the part-two CSI may be discarded, and the part-one CSI may be encoded and multiplexed on the PUSCH. That is, the PUSCH may include three separately encoded UCI messages—UCI1 HARQ-ACK, UCI2 HARQ-ACK, and part-one CSI. In other examples, all four separately-encoded UCI messages may be multiplexed on the PUSCH. In some other examples, UCI1 HARQ-ACK may be encoded with part-one CSI, and UCI2 HARQ-ACK may be encoded with part-two CSI. The two distinct UCI messages may then be multiplexed on the PUSCH. In yet other examples, UCI1 HARQ-ACK is jointly encoded with part-one CSI, and then the three encoded UCI messages are multiplexed on the PUSCH. In other examples, UCI2 HARQ-ACK is jointly encoded with part-two CSI, after which the three distinctly encoded UCI messages are multiplexed on the PUSCH. Lastly, in some examples, UCI2 HARQ-ACK may be jointly encoded with part-one CSI, and the three unique UCI messages may be multiplexed on the PUSCH.

In some examples, the UE transmits a first HARQ-ACK part on a first PUCCH (first PUCCH resource) and a second HARQ-ACK on a subsequent PUCCH (e.g., second PUCCH, second PUCCH resource). In some such examples, the first PUCCH corresponds to the original HARQ-ACK payload prior to transformation into the first and second HARQ-ACK parts. A first DCI may schedule the first PUCCH.

In some examples, the subsequent PUCCH (e.g., second PUCCH) may be a next PUCCH transmission occasion that is dynamically scheduled by a second DCI for a second HARQ-ACK payload. In this example, the second DCI may be received subsequent to (after) receiving the first DCI. In such examples, the network node may first decode the first HARQ-ACK part from the first PUCCH, determine a size of the second HARQ-ACK part, and dynamically allocate an appropriate PUCCH that can accommodate both the second HARQ-ACK part and the second HARQ-ACK payload. In other examples, the second PUCCH may be a next PUCCH transmission occasion that may be semi-statically configured. In such examples, the second PUCCH may be initially scheduled for HARQ-ACK feedback associated with one or more semi-persistently scheduled PDSCHs.

In other examples, a second DCI may schedule the second PUCCH, while referencing the first PUCCH to indicate which pending second HARQ-ACK part should be transmitted. In some examples, the second DCI may not include a downlink (DL) assignment for PDSCH scheduling. As a result, the second PUCCH may not be associated with a second HARQ-ACK payload. The second DCI may use a slot offset, such as a gap between a slot associated with the second DCI and a slot associated with the first PUCCH, to identify the first PUCCH resource (and hence identify the pending second HARQ-ACK part).

In examples in which the second HARQ-ACK part is multiplexed on the second PUCCH, a first HARQ-ACK part associated with a second HARQ-ACK payload may be jointly encoded with the second HARQ-ACK part associated with the first HARQ-ACK payload. The jointly encoded first HARQ-ACK part and second HARQ-ACK part may be multiplexed on the same PUCCH (second PUCCH).

In some examples, the second PUCCH (e.g., second PUCCH resource) may be a dedicated PUCCH resource for transmission of the second HARQ-ACK part. The dedicated PUCCH resource may be configured via RRC signaling, or can be dynamically indicated by a DCI (e.g., the first DCI). In such examples, the second PUCCH resource is not associated with a second original HARQ-ACK payload.

The DCI that dynamically indicates the dedicated PUCCH resource may include two physical uplink control channel (PUCCH) resource indicator (PRI) fields, or a PRI field may indicate two PUCCH resources. Different schemes may be used to determine a slot associated with the second PUCCH. Such schemes may be used in various cases, such as when the DCI indicates both PUCCH resources. For the first PUCCH resource, the slot is determined based on a K1 field (e.g., PDSCH-to-HARQ_feedback timing indicator) included in the first DCI. In some examples, the slot of the second PUCCH resource is the same as the slot of the first PUCCH resource (both based on K1 fields). In other examples, the slot of the second PUCCH resource is a next slot that is configured with “uplink” symbols (e.g., next “U” slot). In other examples, the slot of the second PUCCH resource may be based on a fixed rule. For example, if the first slot (for the first PUCCH resource) is a complete uplink slot (e.g., all symbols configured as uplink), the second slot (for the second PUCCH resource) may be the same as the first slot. Otherwise, if first slot is a special slot with both DL and UL symbols, the second slot is the next slot that is configured with uplink symbols. In other examples, the DCI includes a second K1 fields to indicates the second slot for the second PUCCH resource.

In some examples, if the subsequent PUCCH resource overlaps with a PUSCH, the second HARQ-ACK part may be multiplexed on the PUSCH similar to other aspects of the present disclosure described with reference to multiplexing the second HARQ-ACK part on the PUSCH. In such examples, the second HARQ-ACK part is not always multiplexed on a subsequent PUSCH. Rather, the second HARQ-ACK part may be multiplexed on the subsequent PUSCH when the second PUCCH overlaps with the PUSCH.

In other examples, the first HARQ-ACK part and the second HARQ-ACK part formed from an original HARQ-ACK payload may be multiplexed on the same PUCCH. In such examples, the PUCCH may be a format 3 or format 4 PUCCH. In some such examples, other UCI, such as CSI or a scheduling request (SR), may be multiplexed on the PUCCH resource. In some such examples, if a payload of the SR is present, the payload may be jointly encoded with the first HARQ-ACK, and the UE may transmit two separately encoded UCI messages on the PUCCH resource. In other examples, if one part CSI is present, the one part CSI may be jointly encoded with the first HARQ-ACK, and the UE transmits two separately encoded UCI messages on the PUCCH resource.

In other examples, the CSI may have two parts. In some examples, the part-two CSI may be dropped and the part-one CSI may be jointly encoded with the first HARQ-ACK, and the UE transmits two separately encoded UCI messages ((part-one CSI and first HARQ-ACK part)+(second HARQ-ACK part)) on the PUCCH resource. In other examples, part-one CSI may be jointly encoded with the first HARQ-ACK. Additionally, part-two CSI may be jointly encoded with the second HARQ-ACK, and the UE transmits the two separately encoded UCI messages on the PUCCH. In other examples, part-one CSI may be jointly encoded with the first HARQ-ACK part, also part-two CSI and the second HARQ-ACK part may be separately encoded. The UE may transmit three separately encoded UCI messages on the PUCCH.

In some cases, if the PUCCH overlaps with a PUSCH, the UE may multiplex both HARQ-ACK parts on the PUSCH instead of the PUCCH. In examples where both HARQ-ACK parts are multiplexed on the same PUCCH, the network node may configure PUCCH resources that can accommodate both HARQ-ACK parts. A reliability of HARQ-ACK feedback may be reduced if adequate PUCCH resources are not allocated. Additionally, the network node may still decode the first HARQ-ACK part prior to decoding the second HARQ-ACK part even when the UE multiplexes both HARQ-ACK parts on the same PUCCH.

As discussed, in some cases, a HARQ-ACK payload may include one or more dummy NACKs (e.g., d-NACKs). The d-NACKs may also be referred to as default NACKs. A d-NACK is not a low probability occurrence because the d-NACK is not associated with a decoding failure, such as a DCI decoding failure, a PDSCH decoding failure, or a PDCCH decoding failure. Rather, the d-NACK may be based on one or more scheduling decisions by a network node, such that the d-NACK may occur more frequently than an actual NACK for a decoding failure. Specifically, the d-NACK is a type of NACK (represented as ‘0’) added to the HARQ-ACK payload to ensure the payload sizes (e.g., codebook sizes) between the UE and the network node match. As a result, compression schemes, such as the two part HARQ-ACK compression scheme, may fail to adequately compress the HARQ-ACK payload in the presence of d-NACKs. The d-NACK may be used in different types of HARQ-ACK payload types, such as type 1, type 2, and type 3 HARQ-ACK codebooks (e.g., HARQ-ACK payloads).

Various aspects of the present disclosure are directed to applying a two part HARQ-ACK compression scheme when an original HARQ-ACK payload includes one or more d-NACKs. In some cases, it may be desirable to exclude the d-NACK from the HARQ-ACK payload before implementing the compression or transformation into two part HARQ-ACK. Nevertheless, this may cause a variation in a HARQ-ACK payload size N between the UE and the network, particularly when one or more actual NACKs are associated with a DCI decoding failure. This mismatch may also result in a misalignment on a first size N₁ of a first HARQ-ACK part and/or a second size N₂ of a second HARQ-ACK part.

In some examples, rather than excluding the d-NACKs, a UE may modify the d-NACKs to d-ACKs before the compression process or transformation into two part HARQ-ACK. Modifying the d-NACKs to d-ACKs may maintain alignment of the HARQ-ACK payload size N between the UE and the network. In other examples, the HARQ-ACK payload may be split into two sections. In such examples, one of the sections may be transformed into a two part HARQ-ACK payload. Additionally, in some such examples, another section may report a new data indicator (NDI).

As discussed, the one or more d-NACKs in a HARQ-ACK payload are not associated with a decoding failure. In some cases, the one or more d-NACKs may be included based on a number of code block groups (CBGs). In such cases, CBG-based HARQ-ACK may be configured with a maximum number of CBGs configured as maxCodeBlockGrousPerTransortBlock (N_{HARQ-ACK}^{CBG/TB,max}) for a component carrier (CC). The HARQ-ACK payload may include one or more d-NACKs based on a scheduled transport block (TB) that includes fewer CBGs (N_{HARQ-ACK}^{CBG/TB}) or actual number of scheduled CBGs) than the maximum number of CBGs. For example, d-NACKs may be included in a set of information bits, such as the last N_{HARQ-ACK}^{CBG/TB,max}−(N_{HARQ-ACK}^{CBG/TB} information bits for a TB in the HARQ-ACK payload. This case applies to all HARQ-ACK payload types (e.g., type 1, type 2, and type 3 codebooks). For a Type 2 HARQ-ACK payload, the maximum number of CBGs is further based on a greatest of the maximum number of CBGs for each CC that is configured with the CBG-based HARQ-ACK.

In some cases, a maximum number of codewords per PDSCH is set as ‘2’, and spatial bundling is not configured. In such cases, a second transport block for the HARQ-ACK payload may include one or more d-NACKs based on the PDSCH including one TB (the actual number of scheduled TBs being equal to one). Alternatively, the HARQ-ACK payload may include one or more d-NACKs when the DCI associated with HARQ-ACK does not schedule a PDSCH (e.g., due to semi-persistent scheduling (SPS) release, a transmission configuration indicator (TCI) state update, or secondary cell (SCell) dormancy). This rule for including d-NACKs applies to all HARQ-ACK payload types (e.g., type 1, type 2, and type 3 codebooks). For a type 2 HARQ-ACK payload, the rule is applied to all CCs if at least one configured downlink (DL) bandwidth part (BWP) of at least one CC is configured with maxNrofCodeWordsScheduledByDCI=2. For a type 1 and type 3 HARQ-ACK payload, this rule is applied per CC based on a configuration of maxNrofCodeWordsScheduledByDCI for the CC.

In some cases, a UE may be scheduled to transmit HARQ feedback in a slot n+k. In such cases, the HARQ-ACK payload may include one or more d-NACKs based on the UE receiving a PDSCH in slot n and failing to transmit HARQ feedback in slot n+k (instead, HARQ feedback for the PDSCH is transmitted in another slot other than slot n+k). This case only applies to a type 1 HARQ-ACK payload, where the d-NACK corresponds to a location in the HARQ-ACK payload associated with a candidate PDSCH occasion in slot n.

In some cases, a CBG-based HARQ-ACK may be configured for a CC via a radio resource control (RRC) parameter (PDSCH-CodeBlockGroupTransmission). In such cases, the HARQ-ACK payload may include one or more d-NACKs when a PDSCH is scheduled by a DCI format that does not support CBG-based PDSCH receptions. For example, DCI format 1_0 or 1_2 does not support CBG-based PDSCH receptions. As another example, a DCI associated with a HARQ-ACK payload may not schedule a PDSCH, such as a DCI associated with an SPS release or a TCI state update. In this example, the DCI may not support CBG-based PDSCH receptions. In such cases, the one-bit HARQ-ACK corresponding to a scheduled TB may be repeated N_{HARQ-ACK}^{CBG/TB,max} times. If the one-bit HARQ-ACK is a NACK (scheduled TB is not decoded), the remaining repeated N_{HARQ-ACK}^{CBG/TB,max}−1 bits are d-NACKs. Such cases may apply to a type 1 or type 3 HARQ-ACK payload.

In some cases, for a type 1 HARQ-ACK payload, a UE may fail to decode a scheduling DCI, and as a result, the UE may not receive a TB/CBG. In such cases, the HARQ-ACK payload may include a d-NACK in each occasion corresponding to the TB/CBG that was not received (due to the corresponding DCI not being detected by the UE).

In some cases, for a type 3 HARQ-ACK payload, an NDI may not be scheduled for reporting as part of the HARQ-ACK payload. In some such cases, the HARQ-ACK payload associated with that HARQ identifier (ID) may include one or more d-NACKs when the UE has previously reported HARQ-ACK for a PDSCH reception without scheduling another PDSCH with a same HARQ ID. In other cases, the HARQ-ACK payload associated with that HARQ ID may include one or more NACKs when the UE fails to retrieve HARQ-ACK information for a PDSCH (due to insufficient processing time at the UE), or when a specific HARQ ID has not been used/scheduled yet.

In some cases, for a type 3 HARQ-ACK payload, an NDI may be configured for reporting as part of the HARQ-ACK payload. In some such cases, a HARQ ID may not be scheduled. Therefore, the HARQ-ACK payload may include one or more d-NACKs.

In some examples, the UE may transform an original HARQ-ACK payload (e.g., original HARQ-ACK codebook) into a first HARQ-ACK part and a second HARQ-ACK part in accordance with satisfying a forming condition. The UE may transmit the original HARQ-ACK payload if the forming condition is not satisfied. The forming condition may be a semi-static condition, such as a condition that is configured via an RRC message, or a dynamic condition, such as a condition that is associated with scheduling. In some examples, the condition may be satisfied if the HARQ-ACK payload is a type 2 payload (or is not type 1 or type 3 HARQ-ACK payload). In some such examples, a dynamic forming condition may be satisfied if the HARQ-ACK payload is the type 2 payload and if the network node has not requested a type 3 payload via DCI. In other examples, the forming condition may be satisfied if CBG-based PDSCH reception is not configured. In other examples, the forming condition may be satisfied if a maximum number of codewords per PDSCH is greater than or less than a threshold, such as two. In other examples, the forming condition may be satisfied if the maximum number of codewords per PDSCH is two while spatial bundling is configured. In some examples, based on scheduling, the UE may dynamically determine if each NACK in an original HARQ-ACK payload is a d-NACK or an actual NACK. Accordingly, the UE may not transform the original HARQ-ACK CB into two parts if the original HARQ-ACK payload does not include one or more d-NACKs.

As discussed, in some examples, the UE may dynamically determine whether to transform the original HARQ-ACK payload into a two part HARQ-ACK payload. Such dynamic decisions may occur at each occasion of a HARQ-ACK transmission based on scheduling. In such examples, dynamically determining to transform the original HARQ-ACK payload may result in a mismatch between the UE and the network node. Therefore, in some examples, the network node may indicate whether to transform the original HARQ-ACK payload. In such examples, a field or a bit in a DCI message may indicate whether the UE should transform the original HARQ-ACK payload. In some such examples, the UE may use an indication included in a last DCI that schedules the HARQ-ACK transmission to determine whether to transform the original HARQ-ACK payload into the two part HARQ-ACK payload.

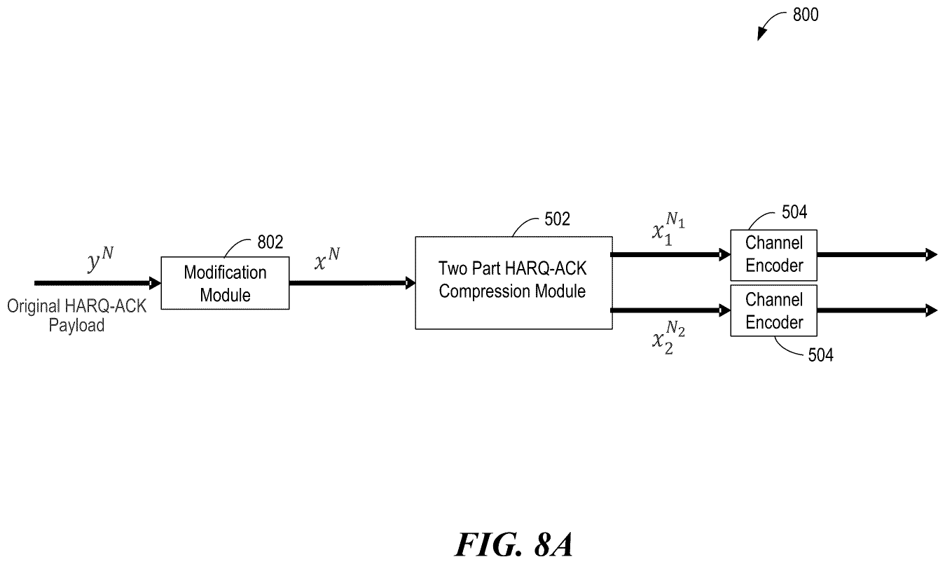

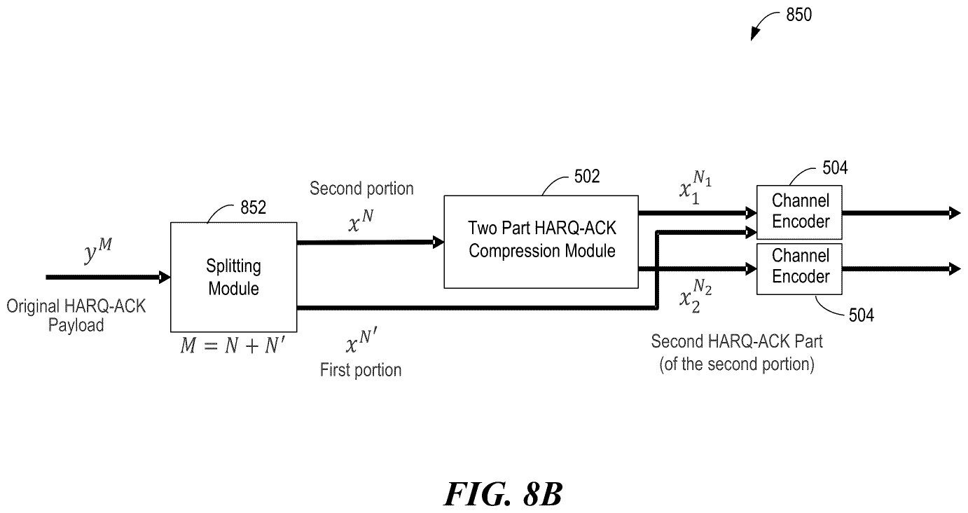

In some examples, the UE may modify the original HARQ-ACK payload before transforming the original HARQ-ACK payload into two parts. FIG. 8A is a block diagram illustrating an example 800 of modifying an original HARQ-ACK payload, in accordance with various aspects of the present disclosure. As shown in the example 800, the UE may generate an original HARQ-ACK payload y^{N} in accordance with receiving one or more downlink transmissions. A modification module 802 may modify one or more bits of the original HARQ-ACK payload y^{N}. For example, each d-NACK in the original HARQ-ACK payload y^{N} may be transformed to a d-ACK. As shown in the example 800, a two part HARQ-ACK compression module 502 may receive the modified HARQ-ACK payload x^{N}. The two part HARQ-ACK compression module 502 may generate the two part HARQ-ACK payload in accordance with the various aspects described with reference to FIG. 5.

As discussed, in some cases, a number of code block groups (CBGs) included in a scheduled transport block (TB) may be less than a maximum number of configured CBGs. In some examples, when the number of CBGs is less than the maximum number of configured CBGs, the modification module 802 may modify d-NACKs in a set of information bits of the original HARQ-ACK payload to d-ACKS. In some such examples, the set of information bits may be the last the last N_{HARQ-ACK}^{CBG/TB,max}−N_{HARQ-ACK}^{CBG/TB} information bits in a TB of the original HARQ-ACK payload.

Additionally, as discussed, in some cases, a maximum number of codewords may be set to a value, such as two, and spatial bundling may not be configured. In such cases, the HARQ payload may include one or more d-NACKs if a PDSCH includes one transport block or if DCI associated with the HARQ-ACK feedback does not schedule a PDSCH. In some examples, if the PDSCH includes one transport block or the DCI associated with the HARQ-ACK feedback does not schedule a PDSCH, the modification module 802 may modify a second transport block of the HARQ-ACK payload (e.g., a position in the HARQ-ACK payload corresponding to a second TB of a PDSCH) to include an ACK, such as a d-ACK, instead of a d-NACK.

Additionally, as discussed, in some cases, a UE may be scheduled to transmit the original HARQ-ACK payload in a slot n+k. In some cases, a value for a bit in the HARQ-ACK payload corresponding to a candidate PDSCH reception occasion in slot n may be set to a d-NACK if the HARQ-ACK payload a PDSCH scheduled in slot n is reported in a slot that is different than the slot n+k. In some examples, the modification module 802 may modify each bit in the HARQ-ACK payload from a d-NACK to an ACK, such as a d-ACK.

Furthermore, as discussed, the UE may repeat a one-bit HARQ-ACK N_{HARQ-ACK}^{CBG/TB,max} times if a PDSCH is scheduled by a DCI format that does not support a HARQ-ACK time CBG-based PDSCH reception. The remaining N_{HARQ-ACK}^{CBG/TB,max}−1 bits of the HARQ-ACK may be a d-ACK or d-NACK. For example, the DCI format may be DCI format 1_0 or 1_2 for a scheduled PDSCH or SPS PDSCH. As another example, the DCI associated with a HARQ-ACK payload may indicate an SPS release or a TCI state update. In some examples, the modification module 802 may generate an ACK, such as a d-ACK for the last N_{HARQ-ACK}^{CBG/TB,max}−1 information bits of the TB in the original HARQ-ACK payload.

In some examples, an original HARQ-ACK payload may be split into a first portion and a second portion, and then one of the portions may be transformed into a two part HARQ-ACK payload. FIG. 8B is a block diagram illustrating an example 850 of splitting an original HARQ-ACK payload, in accordance with various aspects of the present disclosure. In the example 850, the UE may generate an original HARQ-ACK payload y^{M} in accordance with receiving one or more downlink transmissions. A splitting module 852 may split the original HARQ-ACK payload y^{M} into a first portion x^{N′} and a second portion x^{N}. As shown in the example 850, the modified HARQ-ACK payload x^{N} may be received at a two part HARQ-ACK compression module 502. The two part HARQ-ACK compression module 502 may generate the two part HARQ-ACK payload in accordance with the various aspects described with reference to FIG. 5. Furthermore, a channel encoder 504 may process the first portion x^{N′}. The UE may then transmit the encoded first portion x^{N′}, the encoded first HARQ-ACK part, and the encoded second HARQ-ACK part.

In some examples, the first portion x^{N′} may not be compressible. Therefore, the first portion x^{N′} may not be transformed into a two part HARQ-ACK payload. For example, for a type 3 HARQ-ACK payload, when one or more NDIs are configured to be reported as part of a type 3 HARQ-ACK payload, the first portion x^{N′} may include one or more NDIs and the second portion x^{N} may include the HARQ feedback (e.g., ACK/NACK bits). In this example, the first portion x^{N′} is not compressible and the portion x^{N} portion is compressible. In other examples, for a type 2 HARQ-ACK payload with two sub-payloads (e.g., two sub-codebooks), such as a TB-based sub-payload or a CBG-based sub-payload, the first portion x^{N′} may include one sub-payload, such as the CBG-based sub-payload, and the second portion x^{N} may include another sub-payload, such as the TB-based sub-payload. In this example, a compression gain of the first portion x^{N′} may be minimal.

In some examples, as shown in the example 850, a channel encoder 504 may jointly encode the first portion x^{N′} with the first HARQ-ACK part. In other examples (not shown in FIG. 8B), the channel encoder 504 may jointly encode the first portion x^{N′} with the second HARQ-ACK part. In other examples (not shown in FIG. 8B), the channel encoder 504 may separately encode the first portion x^{N′}, the first HARQ-ACK part, and the second HARQ-ACK part.

As noted above, lossless compression for hybrid automatic repeat request acknowledgement (HARQ-ACK) feedback provides a significant overhead reduction compared to standard HARQ-ACK feedback due to the small block error rate (BLER) seen during 5G and later communications. This overhead reduces further in the presence of a correlation between different transmissions received from the network.

Close to optimal compression or entropy can be obtained with two part or two stage HARQ-ACK compression. One or two bits in the first part is generally sufficient. In the simplest form of lossless compression, the first part (e.g., part 1) of the two part HARQ-ACK payload has one bit. The transmitter sets the single bit to ‘1’ if all received code blocks are successfully decoded (e.g., all ACK). In this case, nothing is sent for the second part of the two part HARQ-ACK payload (e.g., part 2). Otherwise, the transmitter sets the single bit in the first part to ‘0’, and sends the full payload in the second part of the two part HARQ-ACK payload.

If loss is to be tolerated in order to further reduce the HARQ-ACK overhead, loss or distortion should be defined, as well as the impact of the loss on the system. Moreover, an optimal (or information-theoretic) rate-distortion function for a selected loss function should be determined. A practical operating regime in the rate-distortion function, and how to achieve this operating regime are now described.

For the information-theoretic rate-distortion formulation, a parameter R may be a rate of compression or source encoding, such that N bits can be compressed to R.N bits, where R<1; and a parameter D is an average distortion between an original sequence and a reconstructed sequence:

$$d ( {x}^{n} , {\hat{x}}^{n} ) = \frac{1}{n} {\sum }_{i = 1}^{n} d ( x , \hat{x} ) ,$$

where xⁿ is the original sequence of length n and \hat{x}ⁿ is the reconstructed sequence. It is assumed that there is no error from channel encoding or channel decoding (e.g., the channel is a noiseless channel or channel coding corrects errors). Thus, distortion results only from compression. The rate-distortion function R(D) is the infimum of rates R such that (R,D) is achievable.

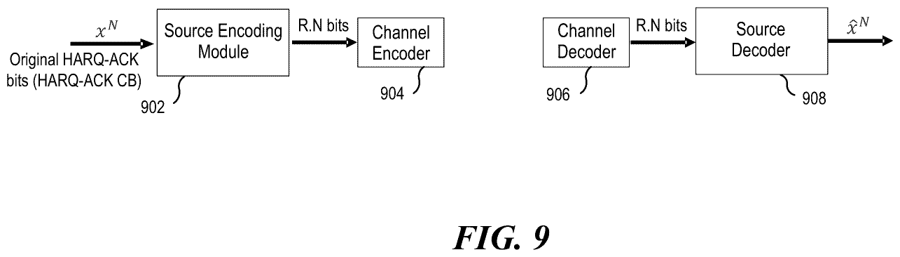

FIG. 9 is a block diagram illustrating lossy compression encoding and decoding, respectively, in accordance with various aspects of the present disclosure. As seen in FIG. 9, an original HARQ-ACK codebook (CB) X^{N} is received at a source encoding module 902. The original HARQ-ACK codebook X^{N} includes a number of bits N. The source encoding module 902 encodes the HARQ-ACK feedback for the bits of the original HARQ-ACK codebook X^{N} to generate a compressed sequence of R.N bits. A channel encoder 904 encodes the compressed R.N bits for transmission to a network device, such as a base station. A channel decoder 906 at the network device decodes the compressed R. N bits for a source decoder 908. The source decoder 908 generates reconstructed bits \hat{x}^{N}, which approximate the original bits of the original HARQ-ACK codebook X^{N}, subject to some amount of distortion resulting from the compression.

Shannon's lossy source coding theorem states that the rate-distortion function for a discrete memoryless source (X, p(x)) and a distortion measure d(x, \hat{x}) is

$$R ( D ) = {min}_{p ( \hat{x} \vert x ) : E ( d ( X , \hat{X} ) ) \leq D} I ( X ; \hat{X} ) .$$

This means that it is not possible to achieve any rate-distortion pair below a rate-distortion curve R (D). This also means that there exists a code that can achieve a given point in the rate-distortion curve R(D) as a value of N increases.

Aspects of the present disclosure introduce techniques for reaching a desired point in the rate-distortion curve R(D). These techniques may include low complexity source encoding schemes and source decoding schemes for operation with small codeword lengths.

For the distortion measure in general lossy compression problems, the Hamming function may be considered where the distortion

$$d ( x , \hat{x} ) = x ⊕ \hat{x} = \{ \begin{matrix}1 , & x \neq \hat{x} \\ 0 , & x = \hat{x}\end{matrix} ,$$

where ⊕ represents an exclusive logical OR (XOR) operation. In the context of HARQ-ACK compression, the Hamming distortion measure is not suitable. For ACK-to-NACK errors, the Hamming distortion measure is acceptable because an error only results in an unnecessary retransmission. Unnecessary transmissions impact the downlink throughput, and if the distortion D is small enough, such impact can be minimized. For NACK-to-ACK errors, no recovery is possible, or recovery may be difficult or costly.

According to aspects of the present disclosure, the distortion is defined to avoid NACK-to-ACK errors at all costs. Hence, the distortion d(x,\hat{x}) is defined as:

$$d ( x , \hat{x} ) = \{ \begin{matrix}1 , & if x = 1 , \hat{x} = 0 \\ ∞ , & if x = 0 , \hat{x} = 1 \\ 0 , & if x = \hat{x}\end{matrix}$$

The impact of the distortion D on the system with the above distortion measure is considered with p₀ being the downlink block error rate (BLER) (e.g., probability of a NACK ‘0’ in the HARQ-ACK codebook). The effective downlink throughput by taking into account the lossy HARQ-ACK compression with the above distortion metric can be calculated as (1−p₀−D)X, where X is a downlink throughput based on a scheduled downlink modulation and coding scheme (MCS). Without distortion, the downlink throughput is (1−p₀)X. If some ACK-to-NACK error is permitted, resulting in average distortion D, while ensuring no NACK-to-ACK errors, the downlink BLER is effectively increased in order to achieve additional HARQ-ACK compression. It can be shown that the rate-distortion for a Bernoulli source with

$$0 \leq {p}_{0} \leq \frac{1}{2}$$

and the above distortion measure is R(D)=

$$\{ \begin{matrix}H ( {p}_{0} ) - ( {p}_{0} + D ) H ( \frac{D}{{p}_{0} + D} ) , & if 0 \leq D < 1 - {p}_{0} \\ 0 , & if D \geq 1 - {p}_{0}\end{matrix} ,$$

where H(.) is a binary entropy function.

The smaller the BLER, the larger the difference between the Hamming distortion and the new distortion becomes. Thus, the penalty for avoiding NACK-to-ACK becomes larger. To mitigate downlink throughput reduction as a result of lossy compression, the distortion should be less than or equal to the downlink BLER (D≤p₀). For a 10% BLER, the UE can reduce the HARQ-ACK overhead by a factor of 1.75 (0.47/0.27) compared to lossless compression at the cost of D=0.1 distortion, which is at the cost of a downlink throughput reduction by a factor of 1.125 (0.9/0.8), while completely avoiding NACK-to-ACK error.

According to aspects of the present disclosure, HARQ-ACK bundling across k bits is one technique for lossy compression. In these aspects, source encoding occurs at the UE. For k bits of a HARQ-ACK payload, the UE transmits one bit corresponding to the logical AND operation of the k bits. This type of encoding will be referred to as bundling. Source decoding at the network occurs such that if the received single bit is ‘1’, the network assumes all ACK k bits of the HARQ-ACK payload are ACK (e.g., 1). If the received single bit is ‘0’, the network assumes all k bits of the HARQ-ACK payload are NACK bits. This technique ensures that NACK-to-ACK errors will not occur. In other words, only two possible codewords are decoded: 00 . . . 0 and 11 . . . 1, each of length k.

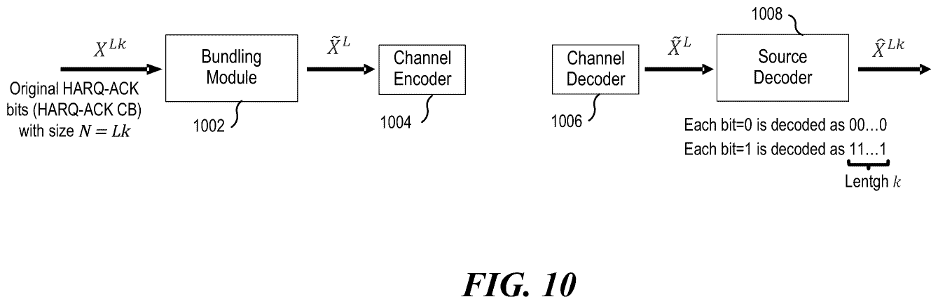

FIG. 10 is a block diagram illustrating bundling and source decoding, in accordance with various aspects of the present disclosure. As seen in FIG. 10, an original HARQ-ACK codebook (CB) X^{Lk} is received at a bundling module 1002. The original HARQ-ACK codebook X^{Lk} includes a quantity of bits N=Lk. The bundling module 1002 bundles the HARQ-ACK feedback for the k bits of the original HARQ-ACK codebook X^{Lk} to generate a sequence of bundled HARQ-ACK bits \tilde{X}^{L}. A channel encoder 1004 encodes the compressed sequence of bundled HARQ-ACK bits \tilde{X}^{L} for transmission to a network device, such as a base station. A channel decoder 1006 at the network device decodes the compressed bits for a source decoder 1008. The source decoder 1008 generates reconstructed bits \hat{x}^{Lk}, which approximate the original bits of the original HARQ-ACK codebook X^{Lk}, subject to some amount of distortion resulting from the compression. Each 0 bit decodes as 00 . . . 0 with length k, and each 1 bit decodes a 11 . . . 1 with length k.

The rate-distortion achieved by this scheme is Rate:

$$R = \frac{1}{k} .$$

The distortion

$$D = E ( d ( {X}^{k} , {\hat{X}}^{k} ) ) = {\sum }_{{x}^{k}} p ( {x}^{k} ) d ( {x}^{k} , {\hat{x}}^{k} ( m ( {x}^{k} ) ) ) = \frac{1}{k} {\sum }_{{x}^{{k}_{\neq 1} k}} p ( {x}^{k} ) w ( {x}^{k} ) + 0 = \frac{1}{k} ( {\sum }_{{x}^{k}} p ( {x}^{k} ) w ( {x}^{k} ) - p ( {1}^{k} ) w ( {1}^{k} ) ) = \frac{1}{k} ( k ( 1 - {p}_{0} ) - {( 1 - {p}_{0} )}^{k} k ) = ( 1 - {p}_{0} ) - {( 1 - {p}_{0} )}^{k} ,$$

whereE (d(X^{k}, \hat{X}^{k})) represents an expectation function, the function representing an average distortion between sequences X^{k} and \hat{X}^{k}.

To implement the bundling, the UE needs to know the bundling size k. The choice of the bundling size k depends on the amount of compression desired. More compression comes at the cost of more distortion. Hence, the network may configure the proper bundling size k. Furthermore, the choice of the bundling size k may depend on the HARQ-ACK payload size (N).

Three options for how the UE may determine the bundling size k will now be described.

In option 0, the bundling size k is a fixed, hard coded number (for example, k=2) that is used when HARQ-ACK bundling for lossy compression is configured to the UE.

In option 1, the bundling size k is a fixed number configured by the network through radio resource control (RRC) configuration. The bundling size k does not depend on the value of the HARQ-ACK payload size N. If the bundling size k is not configured, k=1 (e.g., no bundling) is assumed by the UE. If the bundling size k is RRC configured, a range of this parameter can be limited, e.g., k=2,3 or k=2,3,4, because larger values result in large distortion, impacting downlink throughput.

In option 2, the bundling size k depends on the HARQ-ACK payload size (N). In some cases, where k=N, the UE bundles the entire HARQ-ACK codebook. The dependency can be configured by RRC signaling, for example, configuring the value of k for each possible N, or by configuring threshold N values and the corresponding k. In some aspects, the network configures the thresholds N₀, N₁, . . . , Nₓ and possibly the corresponding values k₀, k₁, . . . , kₓ₊₁, if they are not fixed.

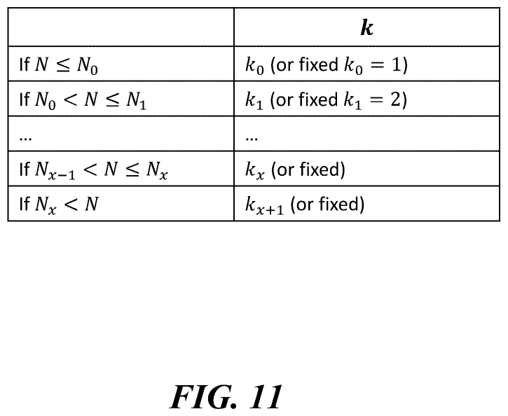

FIG. 11 is a table illustrating bundling size dependencies, in accordance with various aspects of the present disclosure. In the example of FIG. 11, if the value of the HARQ-ACK payload size N is less than or equal to a first threshold value No, then the UE uses the corresponding bundling size k₀, which may be fixed in some implementations. If the value of the HARQ-ACK payload size N is greater than the first threshold value No, but less than or equal to a second threshold value N₁, then the UE uses the corresponding bundling size k₁, which may be fixed in some implementations. Thus, the UE may determine corresponding values for the bundling size k in accordance with which interval the HARQ-ACK payload size N falls, as seen in the example table of FIG. 11.

According to aspects of the present disclosure, quantization may be applied for each of the options for determining the bundling size k. If the value N/k is not an integer, the same bundling size k cannot be assumed for the whole HARQ-ACK codebook.

In a first alternative, the bundling size values are set to k and k+1 for different bundles. In this alternative, the quantity Mod(N,k) bundles have a length k+1, where Mod(is the modulo function. The quantity floor(N/k)−Mod(N,k) bundles have a length k, where floor(is the floor function. Given that each bundle is compressed to one bit, the quantity floor(N/k) bits are generated after source encoding.

In a second alternative, bundling size values are set to k except for the last bundle. In this alternative, the quantity floor(N/k) bundles have a length of k and one bundle has a length of Mod(N,k). Given that each bundle is compressed to one bit, the quantity floor(N/k)+1 bits are generated after source encoding.

Bundling is equivalent to partitioning the 2^{k} possibilities (of length k ACK/NACK bits) into two partitions of: (1) all ones and (2) all other combinations. Thus, bundling results in two codewords after source decoding: 11 . . . 1 and 00 . . . 0.

Aspects of the present disclosure extend the bundling technique into a more general partitioning of the 2^{k} possibilities. In accordance with these aspects, the UE partitions the 2^{k} possibilities into G groups with indices g=1, . . . , G. The UE performs source encoding for k bits of HARQ-ACK to obtain a group index g (also referred to as a partition index). The network source decodes the received group index g, assuming the g'th codeword \hat{x}^{k}(g). There are G codewords overall. The g'th codeword may be the element-wise binary logical AND operation of all members of group g (e.g., to ensure that there is no NACK-to-ACK decoding error). Rate-distortion achieved by this technique is Rate: [log₂ G]/k. The level of distortion depends on the partitioning.

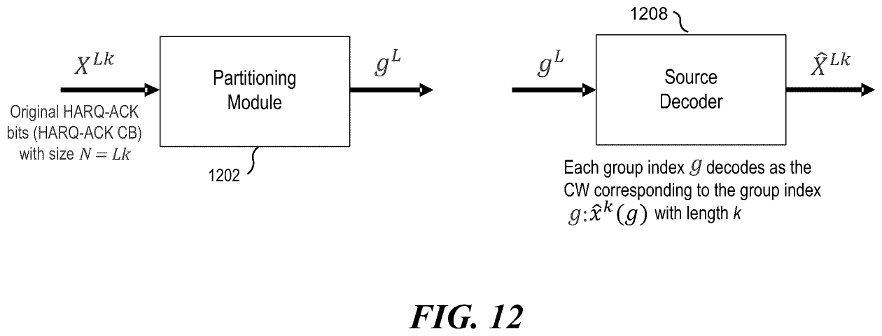

FIG. 12 is a block diagram illustrating partitioning and source decoding, in accordance with various aspects of the present disclosure. As seen in FIG. 12, an original HARQ-ACK codebook (CB) X^{Lk} is received at a partitioning module 1202. The original HARQ-ACK codebook X^{Lk} includes a quantity of bits N=Lk. The partitioning module 1202 partitions the HARQ-ACK feedback for the k bits of the original HARQ-ACK codebook X^{Lk} to obtain a sequence of group or partition indexes g^{L}. A source decoder 1208 at the network device generates reconstructed bits \hat{x}^{Lk}, which approximate the original bits of the original HARQ-ACK codebook X^{Lk}, subject to some amount of distortion resulting from the compression. Each group index g decodes as the codeword corresponding to the group index g:\hat{x}^{k}(g) with length k.

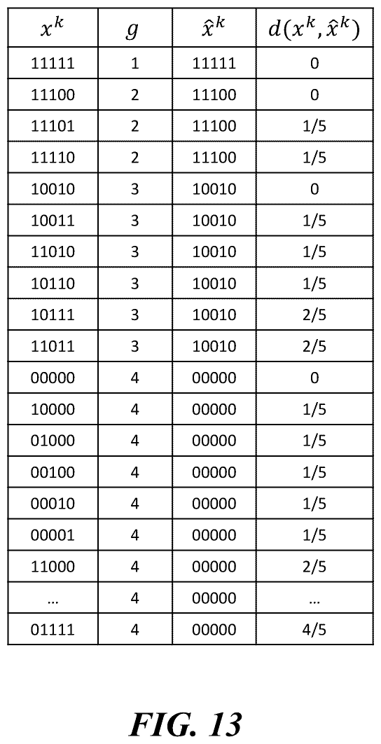

An example of partitioning is now described with respect to FIG. 13. FIG. 13 is a table mapping codewords to group indexes, while showing distortion levels corresponding to reconstructed bits, in accordance with various aspects of the present disclosure. In the example of FIG. 13, the bundling size is k=5, and there are 32 codepoints for G=4 groups. In this example, the codeword x^{k}=11111 is assigned to group g=1. The reconstructed bits \hat{x}^{k} generated by the source decoder based on group index g=1 are also 11111. As a result, the distortion d(x^{k}, \hat{x}^{k})=0. In this example, the codewords x^{k}=11100, 11101, and 1110 are assigned to group g=2. The reconstructed bits \hat{x}^{k} generated by the source decoder based on group index g=2 are 11100. Depending on the actual original codeword x^{k}, the distortion d(x^{k}, \hat{x}^{k})=0 or ⅕=20%. In this example, the codewords x^{k}=10010, 10011, 11010, 10110, 10111, and 11011 are assigned to group g=3. The reconstructed bits \tilde{x}^{k} generated by the source decoder based on group index g=3 are 10010. Depending on the actual original codeword x^{k}, the distortion d(x^{k}, \hat{x}^{k})=0, ⅕=20%, or ⅖=40%. The values and corresponding distortion levels for group 4 are also shown in the example of FIG. 13.

Similar to bundling, for partitioning, the UE needs to know the value of k as well as how to perform quantization if N/k is not an integer. Options 0-2 and the first and second alternatives discussed with respect to bundling are equally applicable to partitioning. However, for partitioning, the UE additionally needs to know the group index g for each codepoint corresponding to k bits of the original HARQ-ACK bits for source encoding. The following discussion focuses on the k bits that are to be encoded into a group index g.

In a first option for determining the group index for a source codeword g(x^{k}) for source encoding, it is assumed that the UE knows the codewords.

At step 1, the UE determines the G codewords of length k corresponding to possible source decoding outcomes: \hat{x}^{k}(g) for g=1,2, . . . , G. These codewords are either signaled by the network to the UE explicitly, for example, through RRC configuration, or are determined by the UE based on a fixed or specified codebook. If the UE determines the codewords, the network may only signal the number of codewords, which is the value of G. If the codewords are signaled, only G−1 codewords are signaled to the UE given that one codeword has to be all 0's. Otherwise x^{k} may be equal to all 0's cannot be mapped to any codeword given that NACK-to-ACK errors are not allowed.

At step 2, for a given k-bit HARQ-ACK sequence x^{k}, the UE selects the codeword that results in a smallest distortion d(xⁿ, \hat{x}^{k}(g)). In other words,

$$g ( {x}^{k} ) = {g}^{*} = {arg min}_{g ∈ \{ 1 , 2 , … , G \}} d ( {x}^{n} , {\hat{x}}^{n} ( g ) ) .$$

More specifically, if there is a ‘0’ (e.g., NACK) in the i'th place (1≤i≤k) of the sequence x^{k}, all codewords with a ‘1’ (e.g., ACK) in the same i'th place are eliminated. This process ensures no NACK-to-ACK error occurs. The UE selects the codeword, from among other remaining codewords, that minimizes the Hamming distance (e.g., a number of places with ‘1’ in x^{k} and ‘0’ in a codeword given that only ACK-to-NACK errors are allowed.) If multiple codewords result in the same minimum distance, the UE selects the codeword with the smallest index.

Some examples will now be described for determining the group index. In these examples, G=4 and the four codewords of length k=5 are 11111, 11100, 10010, and 00000, which are either signaled to the UE or are given by a fixed codebook and by the network configuring the number of codewords G=4.

In a first example, source encoding of x^{k}=10111. The first and second codewords (11111 and 11100) are eliminated. Among the third and fourth codewords (10010 and 00000), the codeword 10010 has a smaller Hamming distance corresponding to ACK-to-NACK errors (⅖ versus ⅘). Therefore, g(10111)=3.

$$d ( {x}^{k} , {\hat{x}}^{k} ( 1 ) ) = d ( 10111 , 11111 ) = ∞$$

$$d ( {x}^{k} , {\hat{x}}^{k} ( 2 ) ) = d ( 10111 , 11100 ) = ∞$$

$$d ( {x}^{k} , {\hat{x}}^{k} ( 3 ) ) = d ( 10111 , 10010 ) = 2 / 5$$

$$d ( {x}^{k} , {\hat{x}}^{k} ( 4 ) ) = d ( 10111 , 00000 ) = 4 / 5$$

In a second example, source encoding of x^{k}=01111. The first three codewords are eliminated. Hence, g(01111)=4. Even though 01111 and 00000 differ in four places, the fourth codeword is the only choice given that NACK-to-ACK error is not permitted.

$$d ( {x}^{k} , {\hat{x}}^{k} ( 1 ) ) = d ( 01111 , 11111 ) = ∞$$

$$d ( {x}^{k} , {\hat{x}}^{k} ( 2 ) ) = d ( 01111 , 11100 ) = ∞$$

$$d ( {x}^{k} , {\hat{x}}^{k} ( 3 ) ) = d ( 01111 , 10010 ) = ∞$$

$$d ( {x}^{k} , {\hat{x}}^{k} ( 4 ) ) = d ( 01111 , 00000 ) = 4 / 5$$

A second option for how the UE may determine the codeword g(x^{k}) for source encoding is now described. In the second option, without the UE knowing the codewords, the group index for each possible codepoint (x^{k}) is signaled to the UE by RRC signaling. In this second option, the choice of codewords is up to the network, and the UE does not need to know the choice. However, to avoid NACK-to-ACK error, g'th codewords should be the element-wise binary AND of all members of group g. Three alternatives for signaling in the second option are now described.

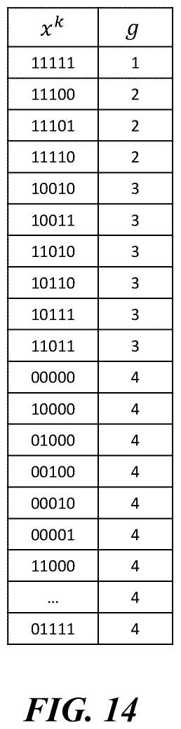

In a first alternative, for each value of k, the network signals a group index g for each of the 2^{k} codepoints for each binary sequence of length k. FIG. 14 is a portion of the table shown in FIG. 13, mapping codewords to group indexes, in accordance with various aspects of the present disclosure. In this first alternative, the network signals a mapping, such as that shown in FIGURE FF, to the UE.

In a second alternative, for each value of k, the network indicates G lists, where each list corresponds to a group and includes the codepoints that belong to this group.

In a third alternative, which has lower overhead but is less flexible than the first two alternatives, both the UE and network assume a same ordering across the 2^{k} codepoints. For each value of k, the network indicates the number of members m_{g} for each group, G−1 values because the number of members for the last group can be determined.

In case both bundling and partitioning are options for lossy HARQ-ACK compression, the network can configure either bundling or partitioning, for example with RRC signaling. Even though bundling is a special case of partitioning, one of these two techniques may be explicitly configured, given that bundling is easier to configure, with no need to indicate codewords or partitions.

In some aspects of the present disclosure, lossy HARQ-ACK compression may be enabled or disabled. In a first alternative for enabling/disabling, the network configures the UE (e.g., with RRC signaling) for whether or not to perform bundling/partitioning. In a second alternative, a MAC-CE activates or deactivates bundling/partitioning. In a third alternative, the network dynamically signals to the UE (e.g., with downlink control information (DCI)) as to whether bundling/partitioning should be performed. Downlink DCI that schedules HARQ-ACK can indicate whether bundling/partitioning is to be performed. In case of multiple downlink DCI messages pointing to a same HARQ-ACK codebook, the indication may be based on the last received DCI message. In some aspects, a one-bit field indicates whether or not to perform bundling/partitioning. The presence of this field can be RRC configured per DCI format. That is, the network may enable or disable the dynamic signaling itself.

In some aspects, the UE indicates through UE capability signaling whether lossy HARQ-ACK compression is supported. In case both bundling and partitioning are options for lossy HARQ-ACK compression, the UE can further indicate support of both bundling and partitioning or support of only bundling.

As noted above, lossless compression for hybrid automatic repeat request acknowledgement (HARQ-ACK) feedback provides a significant overhead reduction compared to standard HARQ-ACK feedback due to the small block error rate (BLER) seen during 5G and later communications. This overhead reduces further in the presence of correlation between different transmissions received from the network.

Close to optimal compression or entropy can be obtained with two part or two stage HARQ-ACK compression. One or two bits in the first part is generally sufficient. In the simplest form of lossless compression, the first part (e.g., part 1) of the two part HARQ-ACK payload has one bit. The transmitter sets the single bit to ‘1’ if all received code blocks are successfully decoded (e.g., all ACK). In this case, nothing is sent for the second part of the two part HARQ-ACK payload (e.g., part 2). Otherwise, the transmitter sets the single bit in the first part to ‘0’, and sends the full payload in the second part of the two part HARQ-ACK payload.

As noted above, a loss function may be defined as one (1) for ACK-to-NACK error (1→0) error; and infinity (∞) for NACK-to-ACK error (0→1). This definition ensures that NACK-to-ACK decoding never occurs, as it is difficult or impossible to recover from a NACK-to-ACK error.

Two quantization schemes: 1) bundling; and 2) partitioning may be considered. Bundling alone may fail to obtain an optimal rate-distortion curve. The same is true for partitioning with short code words, given that long code words cannot be used for HARQ-ACK feedback. Moreover, partitioning is complicated and requires more signaling overhead, even if partitioning can achieve a good rate-distortion pair.

According to aspects of the present disclosure, after bundling or partitioning (which is a quantization that reduces the size but introduces distortion), further compression may be applied to reduce the overhead by using lossless source coding techniques such as two part HARQ-ACK compression. Further compression is possible because even after bundling or partitioning, the codepoints are not equally likely.

For example, assume that the original HARQ-ACK codebook is an independent and identically distributed (iid) binary source with a probability of 0 (e.g., NACK) being defined as p₀ (e.g., Bernoulli(p₀)). For HARQ-ACK feedback, the probability p₀ corresponds to a downlink BLER, for example, 0.1. If the receiver bundles k bits (e.g., logical AND of k bits), prob(bundled Ack=0)=1−(1−p₀)^{k}:=\tilde{p}₀. In other words, after bundling, the probability of zero (e.g., NACK) for the new alphabet of the bundle is Berounlli(\tilde{p}₀). If p₀=0.1 and k=2, then \tilde{p}₀=0.19. Thus, the entropy of the new alphabet is ˜0.7. Hence, the new alphabet is compressible losslessly, and two part HARQ-ACK compression can be applied to the new alphabet to further reduce the overhead. As discussed below, the concatenation of bundling/partitioning and two part HARQ-ACK compression is able to achieve close to the optimal rate-distortion curve.

According to aspects of the present disclosure, a UE may be configured to transform a sequence of bundled HARQ-ACK bits into a two part HARQ-ACK payload. In some aspects, for bundling: each k bits of the original HARQ-ACK codebook are bundled into one bit corresponding to a logical AND operation of the k bits. This bundling reduces the payload but introduces distortion. To generate the two part HARQ-ACK payload, the sequence of bundled HARQ-ACK bits, with length L are transformed to a first part (e.g., part 1) of the HARQ-ACK payload and a second part (e.g., part 2) of the HARQ-ACK payload. The transformation reduces the payload or average payload further but does not introduce any additional distortion.

In some aspects, the length of the first part L₁ is fixed. That is, the length of the first part L₁ is not a function of \tilde{X}^{L} meaning that part 1 has a fixed size for a given L. The length of the second part L₂ is variable and is a function of X₁^{L}^{₁}. That is, part 2 has a variable length depending on the part 1 payload.

In the simplest form, part 1 has one bit, L₁=1. The UE sets the single bit to ‘1’ if \tilde{X}^{L} is all 1's (e.g., logical AND of \tilde{X}^{L} bits, which is equivalent to logical AND of X^{Lk} bits). In this case, the transmitter sends no bits on part 2. Otherwise, the transmitter sets the single bit to ‘0’, and sends the full sequence of bundled HARQ-ACK bits \tilde{X}^{L} in part 2.

The base station first decodes part 1 of the payload and then determines the length of part 2. The base station then decodes part 2 and determines the bits of the bundled HARQ-ACK sequence \tilde{X}^{L}. This compression technique is lossless. For each bit of the bundled HARQ-ACK sequence \tilde{X}^{L}, if the bit is 1, the base station assumes k 1's for the original HARQ-ACK codebook; if the bit is 0, the base station assumes k 0's for the original HARQ-ACK codebook. Thus, the base station obtains the original HARQ-ACK codebook X^{Lk} with some distortion.

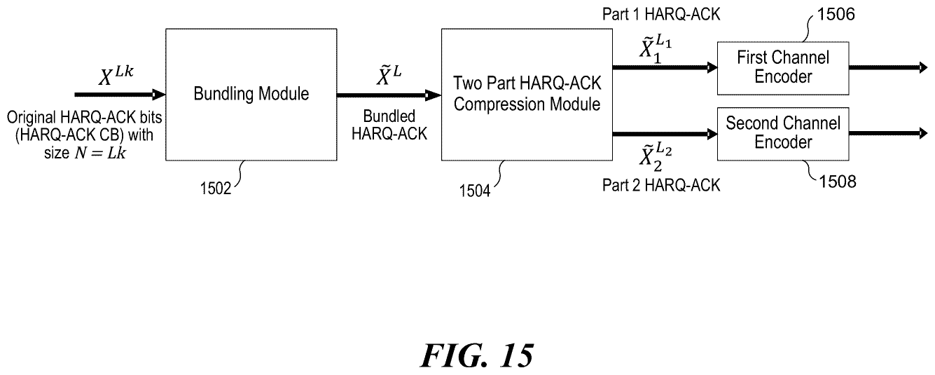

FIG. 15 is a block diagram illustrating concatenating of bundling and two part HARQ-ACK compression, in accordance with various aspects of the present disclosure. Concatenating means initially bundling (or converting) a HARQ-ACK codebook into a partition, and then transforming the bundled/converted HARQ-ACK partitions into a two-part HARQ payload. As seen in FIG. 15, an original HARQ-ACK codebook (CB) X^{Lk} is received at a bundling module 1502. The original HARQ-ACK codebook X^{Lk} includes a number of bits N=Lk. The bundling module 1502 bundles the HARQ-ACK feedback for the k bits of the original HARQ-ACK codebook X^{Lk} to generate a sequence of bundled HARQ-ACK bits \tilde{X}^{L}. A two part HARQ-ACK compression module 1504 transforms the sequence of bundled HARQ-ACK bits \tilde{X}^{L} into a two part HARQ-ACK payload, including a first part \tilde{X}₁^{L}^{₁} and a second part \tilde{X}₂^{L}^{₂}. A first channel encoder 1506 encodes the first part \tilde{X}₁^{L}^{₁} and a second channel encoder 1508 separately encodes the second part \tilde{X}₂^{L}^{₂}, for transmission to a network device, such as a base station.

According to further aspects of the present disclosure, LIE capability signaling is introduced for concatenating. In these aspects, the LIE indicates, through LIE capability signaling, whether or not the concatenation of bundling and transforming to two part HARQ-ACK is supported.

In other aspects, a network may configure the concatenation of bundling and transforming to two part HARQ-ACK with radio resource control (RRC) signaling. In still other aspects, downlink control information (DCI) may dynamically enable or disable the concatenation. In these aspects, downlink DCI that schedules HARQ-ACK transmissions can indicate the enabling/disabling. In case multiple downlink DCI messages point to the same HARQ-ACK codebook, the indication may be based on the most recent DCI.

The DCI may enable the concatenation or disable the concatenation. Disabling may include only performing the bundling, only performing the two part HARQ-ACK transformation, or disabling both the bundling and also the two part HARQ-ACK transformation. A field in the DCI with one or two bits may provide such indication. The presence of this field may be configured by RRC signaling in accordance with a downlink DCI format. Thus, the dynamic indication of the concatenation itself can be disabled by the network, if not needed, per DCI format. That is, based on the configuration, one DCI format (e.g., DCI format 1_1) may include the field and hence can dynamically provide such indication, while another DCI format (e.g., DCI format 1_2) may not include the field and hence cannot dynamically provide such indication.

According to aspects of the present disclosure, the concatenation may be enabled or disabled depending on a length of the original HARQ-ACK codebook (N) and/or a bundling size (k). The concatenation may be enabled or disabled depending on the length of the original HARQ-ACK CB (N), for example, because reducing the HARQ-ACK payload by both bundling and two part HARQ-ACK compression may not be needed for small values of the original HARQ-ACK codebook N. Accordingly, either bundling or two part HARQ-ACK compression may be sufficient. In some cases, neither technique may be needed, for example, for N=2.

The concatenation may be enabled or disabled depending on the bundling size (k) because the value of k impacts how compressible the bundled HARQ-ACK is. In other words, entropy of the bundled HARQ-ACK depends on the value of k. For example, if k is such that the probability \tilde{p}₀=1−(1− p₀)^{k}˜½, the bundled HARQ-ACK is not losslessly compressible.

The concatenation may be enabled or disabled depending on both the length of the original HARQ-ACK CB (N) and the bundling size (k). For example, if the number of bits after bundling (L)=N/k becomes too small, e.g., if k is large enough and N is small enough, then transforming the bundled HARQ-ACK into a two part HARQ-ACK payload may not be needed.

The best rate-distortion pair that concatenation is able to achieve for an iid Bernoulli sequence X^{Lk} with a probability of 0 (p₀) is the rate (combined lossy and lossless): H(\tilde{p}₀)/k, where \tilde{p}₀=1−(1− p₀)^{k} and H(.) is the entropy of the bundled sequence. Without the two part HARQ-ACK compression (e.g., only bundling), the rate becomes 1/k. Entropy coding can achieve the rate H(\tilde{p}₀), while two part HARQ-ACK compression can get very close to this rate. How close depends on how complicated the two part HARQ-ACK processing is, as well as the size of the bundled HARQ-ACK (L=N/k). The distortion can be calculated as (1−p₀)−(1−p₀)^{k}. In order to achieve or get close to the rate above, the design of two part HARQ-ACK compression may be complicated, which requires exhaustive searching. Alternatively, the simplest form of two part HARQ-ACK compression (with one bit for part one) may be employed for the lossless compression after bundling.

As described above, segmentation into multiple blocks may improve performance of simple two part HARQ-ACK compression. That is, for each segment, the UE sends ‘1’ in the first part and nothing in the second part if all bits are 1. Otherwise, the UE sends ‘0’ in the first part and the whole segment in the second part.

According to aspects of the present disclosure, bundled HARQ-ACK bits (\tilde{X}^{L}) are divided into multiple segments/blocks. In these aspects, the simplest two part HARQ-ACK transformation is applied to each segment/block separately.

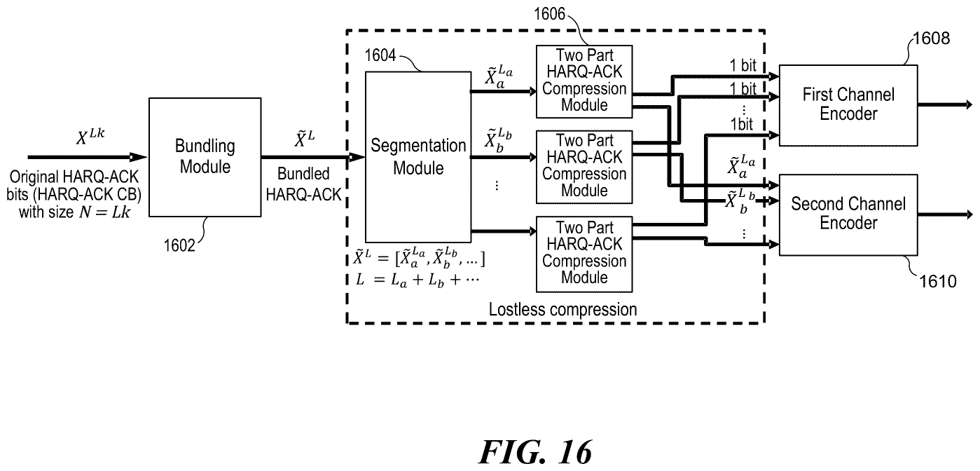

FIG. 16 is a block diagram illustrating segmenting of bundled HARQ-ACK bits, in accordance with various aspects of the present disclosure. As seen in FIG. 16, an original HARQ-ACK codebook X^{Lk} is received at a bundling module 1602. The original HARQ-ACK codebook X^{Lk} includes a number of bits N=Lk. The bundling module 1602 bundles the HARQ-ACK feedback for the k bits of the original HARQ-ACK codebook X^{Lk} to generate a sequence of bundled HARQ-ACK bits \tilde{X}^{L}.

A segmentation module 1604 segments the sequence of bundled HARQ-ACK bits \tilde{X}^{L} into M blocks such that \tilde{X}^{L}=[\tilde{X}ₐ^{L}^{ₐ}, \tilde{X}_{b}^{L}^{_{b}}, . . . ] and L=Lₐ+L_{b}+ . . . . Each of the M blocks \tilde{X}ₐ^{L}^{ₐ}, \tilde{X}_{b}^{L}^{_{b}}, . . . , is then separately transformed by a two part HARQ-ACK compression module 1606 (only one module labeled for ease of illustration) into a two part HARQ-ACK payload, including a first part and a second part. The first part of the HARQ-ACK payload for each segment/block has one bit in the example of FIG. 16. The UE sets the bit to ‘1’ if all bits of the segment/block of the bundled HARQ-ACK sequence are one. The UE sets the single bit to ‘0’ otherwise. A first channel encoder 1608 encodes the first parts from each of the M segments/blocks together, for transmission to a network device, such as a base station.

The second part of the HARQ-ACK payload for each segment/block has a size of either 0 (if the first part is set to ‘1’) or has a size equal to the length of the segment/block (if the first part is set to ‘0’) in which case the second part becomes the whole segment/block of the bundled HARQ-ACK sequence, as shown in the example of FIG. 16. A second channel encoder 1610 encodes the second parts from each of the M segments/blocks together, for transmission to a network device.

As previously discussed, simple bundling has been assumed for the lossy compression. Bundling quantizes k bits to 1 bit, and is very effective, especially when concatenated with lossless compression. However, a more general form of quantization, which is partitioning, may also be considered. It is noted, however, that partitioning with a small value of k may not meaningfully outperform bundling.

According to aspects of the present disclosure, a UE may be configured to transform a sequence of group indices into two parts, where each group index corresponds to k bits of the original HARQ-ACK codebook. The group index is a result of partitioning, as discussed above in more detail. Each k bits of the original HARQ-ACK codebook are mapped to a group index depending on the value of the k bits: (x₁, x₂, . . . , xₖ)→g, where g∈{1,2, . . . , G}. This partitioning reduces the payload by quantizing 2^{k} possibilities to G possibilities. The partitioning, however, introduces distortion. It is noted that bundling is a special case of partitioning, where g∈{0,1} and is the binary AND operation of the k bits. The sequence of group indices g^{L}, with length L, are then transformed into a part one HARQ-ACK payload and a part two HARQ-ACK payload. The transformation reduces the payload or average payload further but does not introduce additional distortion.

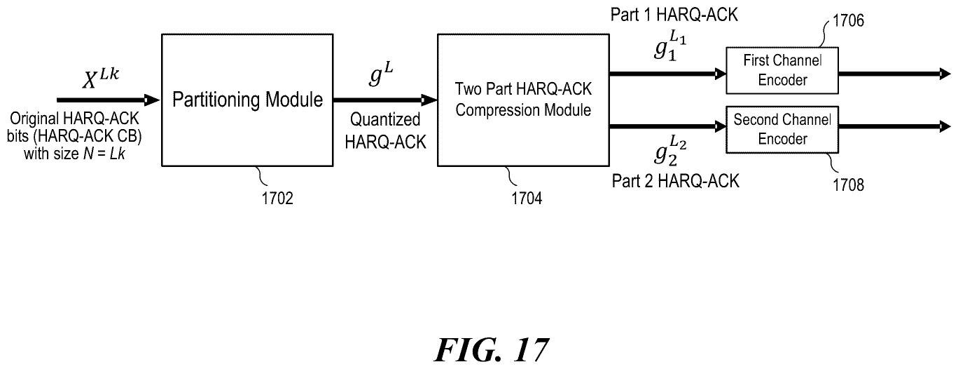

FIG. 17 is a block diagram illustrating concatenating of partitioning and two part HARQ-ACK compression, in accordance with various aspects of the present disclosure. As seen in FIG. 17, an original HARQ-ACK codebook X^{Lk} is received at a partitioning module 1702. The original HARQ-ACK codebook X^{Lk} includes a number of bits N=Lk. The partitioning module 1702 encodes each block of k bits of the original HARQ-ACK codebook X^{Lk} into a partition (or group index) g to generate multiple partitioned HARQ-ACK bits g^{L}. A two part HARQ-ACK compression module 1704 transforms the multiple partitioned HARQ-ACK bits g^{L} into a two part HARQ-ACK payload, including a first part g₁^{L}^{₁} and a second part g₂^{L}^{₂}. A first channel encoder 1706 encodes the first part g₁^{L}^{₁} and a second channel encoder 1708 separately encodes the second part g₂^{L}^{₂} for transmission to a network device. Although not shown in FIG. 17, block-wise two part HARQ-ACK compression (see FIG. 16) can be applied as well.

A type-1 HARQ-ACK codebook is determined via semi-static information, based on candidate physical downlink shared channel (PDSCH) occasions. The user equipment (UE) does not account for physical downlink control channel (PDCCH) monitoring occasions for type-1 HARQ-ACK codebooks. The UE determines the set of PDSCH occasions on a per downlink (DL) serving cell basis. A set of configured K1 values is a set of possible slot timing offset values that can be indicated by downlink control information (DCI). The K1 offset is the time delay between the PDSCH slot and the HARQ-ACK slot. The set of configured K1 values includes {1,2,3,4,5,6,7,8} if only DCI format 1_0 is configured and DCI format 1_1 is not configured in the serving cell. On the other hand, if DCI format 1_1/1_2 is configured for the serving cell, then the set of configured K1 values is provided by the parameter dl-DataToUL-ACK, to indicate the set of possible values for the HARQ feedback timing, where the DCI indicates one value from the set of possible values for the HARQ feedback timing.

For each K1 value, a set of PDSCH time domain resource allocation (TDRA) candidates corresponds to a start and length indicator value (SLIV) within a slot. TDRA candidates that overlap with semi-static uplink symbols are removed for time division duplex (TDD) configurations. The remaining TDRA candidates are grouped such that a number of groups is a maximum number of non-overlapping SLIVs in the slot. The grouping is unnecessary if the maximum number of PDSCHs per slot is one, based on UE capability reporting or radio resource control (RRC) configuration.

A type-1 HARQ-ACK codebook accommodates as many bits as there are potential PDSCH receptions, even though only a subset of the PDSCHs may be actually scheduled. For example, if the TDRA includes SLIVs for symbols {0-6} and {7-13}, there are two bits per K1 value per component carrier. Thus, if K1={1,2,3}, there are 2*3 bits per component carrier for frequency division duplex (FDD) configurations. There are slightly fewer bits for TDD configurations, depending on how many SLIVs overlap with uplink symbols. The specifications in 3GPP 38.213, section 9.1.2 describe two steps for HARQ-ACK codebook determination: step 1: PDSCH occasion determination, based on K1 set and SLIVs; and step 2: HARQ-ACK codebook determination, based on PDSCH occasions.

For a type-1 HARQ-ACK codebook, a NACK (e.g., 0) placed in the codebook associated with a given candidate PDSCH occasion may be due to three types of events. Event 1: A DCI scheduling a PDSCH in that candidate PDSCH occasion is detected, but the PDSCH or transport block (TB) is not successfully decoded. This type of event is a true NACK that should happen with low probability, for example, a 10% probability if the PDSCH block error rate (BLER) is 10%. Event 2: A DCI scheduling a PDSCH in that candidate PDSCH occasion is missed. The base station sent the DCI (as well as the scheduled PDSCH), but the UE did not detect the DCI (and hence, did not attempt to receive the scheduled PDSCH). This event is also a true NACK for DCI that should occur with low probability, for example, a 1% probability. Event 3: A PDSCH is not scheduled in a corresponding candidate PDSCH occasion. This type of event is not a real NACK but is needed to avoid codebook size mismatch. The third type of event may occur frequently, depending on scheduling decisions at the base station and/or traffic patterns.

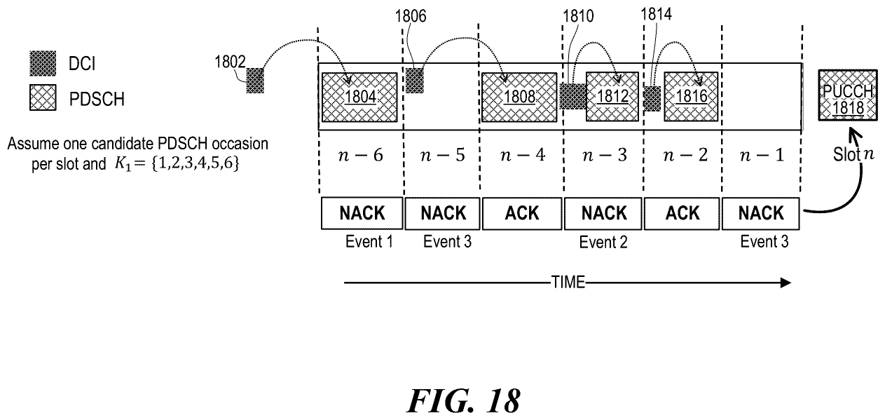

FIG. 18 is a diagram illustrating different types of negative acknowledgement (NACK) events, in accordance with various aspects of the present disclosure. In the example of FIG. 18, a single candidate PDSCH occasion occurs in each slot and the set of K1 values={1, 2, 3, 4, 5, 6}. In the example of FIG. 18, a first DCI message 1802 indicates a first PDSCH 1804 is scheduled at slot n-6. Because the UE detects the first DCI message 1802 but is unable to decode the first PDSCH 1804 scheduled by the first DCI message 1802, the UE generates a first NACK, which is an event 1 NACK, for slot n-6. At slot n-5, no PDSCH is scheduled. Thus, the NACK for slot n-5 is an event 3 NACK. A second DCI message 1806 schedules a second PDSCH 1808 for slot n-4. Because the UE successfully decodes the second PDSCH 1808, the UE generates an ACK for slot n-4. At slot n-3, the UE misses a third DCI message 1810 for a third PDSCH 1812. Thus, the UE generates an event 2 NACK for slot n-3. For slot n-2, the UE receives a fourth DCI message 1814 scheduling a fourth PDSCH 1816. After successfully decoding the fourth PDSCH 1816, the UE generates an ACK for slot n-2. At slot n-1, no PDSCH is scheduled. Thus, the NACK for slot n-1 is an event 3 NACK. At slot n, the UE transmits a physical uplink control channel (PUCCH) 1818 including the four NACKs and the two ACKs corresponding to the previous six slots.

An issue with type-1 HARQ-ACK codebooks is that the UE cannot distinguish between event 2, DCI misdetection, and event 3 where nothing is scheduled. HARQ-ACK compression techniques are affected by the UE's inability to distinguish the event types. Aspects of the present disclosure address this issue for compression schemes including: lossless compression with two part HARQ-ACK; and lossy compression with bundling, which were both previously described in detail. A brief recap of these two types of compression is now provided.

Scheme 1 refers to lossless compression with simple two part HARQ-ACK with one bit bundled part one. For a type-1 HARQ-ACK codebook, if at least one candidate PDSCH occasion is not scheduled, then the single bit part one (e.g., first HARQ-ACK part) is set to NACK (e.g., 0) and the UE sends the entire codebook in a second HARQ-ACK part. If the UE sends the entire codebook frequently, the HARQ-ACK overhead may increase. That is, instead of the UE sending N bits, the UE would frequently send 1+N bits.

Scheme 2 refers to lossy compression with bundling. In this scheme, the UE sends a logical AND of all the ACK/NACK bits. If all bits are ACK, the UE sends an ACK. Otherwise, the UE sends a NACK. For a type-1 HARQ-ACK codebook, if at least one candidate PDSCH occasion is not scheduled, the UE sends a NACK even though all DCI messages have been detected and all PDSCHs have been decoded.

To address the indistinguishability between NACK event types, the UE only considers scheduled PDSCHs when performing logical AND bundling, either in part one of scheme 1, or in scheme 2. However, because the UE cannot distinguish event 2 versus event 3, aspects of the present disclosure introduce additional mechanisms.

In a first approach, signaling is added in the DCI, counter downlink assignment index (DAI) or total DAI, to enable the UE to determine whether a DCI is missed. The bundled bit is set to ‘0’ if either at least one PDSCH is not decoded or at least one DCI is missed. The first approach adds constant DCI overhead and may not be aligned with the type-1 HARQ-ACK codebook structure.

In a second approach, the UE indicates how many ACKs are bundled. Then, even if the bundled ACK is ‘1’, the network is able to determine if a DCI is missed. That is, the network effectively interprets the bundled ACK as ‘0’, and can reschedule PDSCHs or request the full HARQ-ACK codebook. More details of the second approach will now be discussed.

According to aspects of the present disclosure, when a UE bundles HARQ-ACK bits (e.g., performing a logical AND operation on multiple bits of a HARQ-ACK codebook), the UE also indicates information related to a quantity of ACKs (e.g., l's), in addition to the bundled bit, as part of the HARQ-ACK payload. These aspects have particular applicability for type-1 HARQ-ACK codebooks. With type-1 HARQ-ACK codebooks, the HARQ-ACK bits to be bundled are only based on the received PDSCHs and not all candidate PDSCH reception occasions. These aspects exclude the HARQ-ACK bits associated with candidate PDSCH receptions that the UE does not receive due to the UE not detecting a corresponding DCI format, either due to DCI misdetection or due to the base station not scheduling, as the UE cannot distinguish between these cases. If semi-persistent scheduling (SPS) is also configured, SPS PDSCHs may also be considered, even though not scheduled by a DCI.

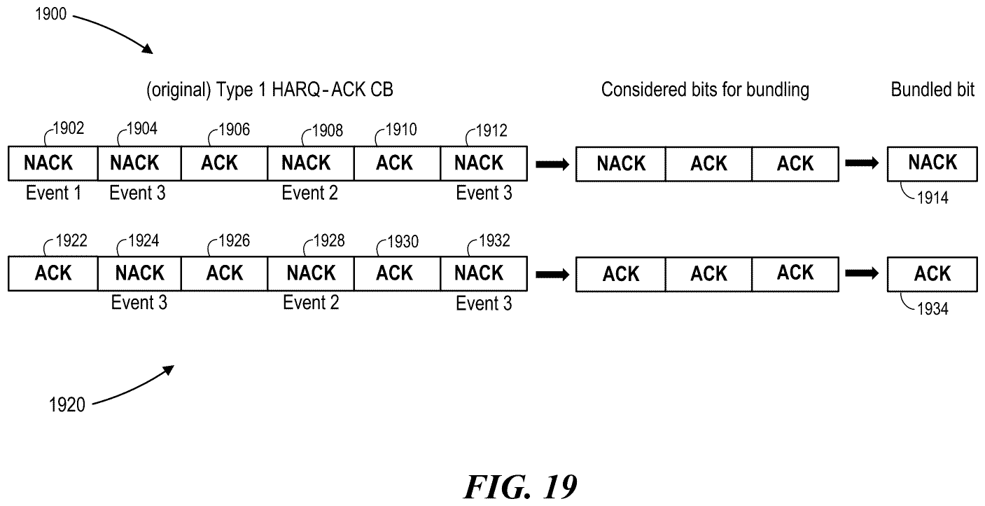

FIG. 19 is a diagram illustrating examples of bundling positive acknowledgement/negative acknowledgement (ACK/NACK) bits, in accordance with various aspects of the present disclosure. In a first example 1900 of FIG. 19, an original type-1 HARQ-ACK codebook includes six ACK/NACK bits. A first bit 1902 is a NACK for a type one event. A second bit 1904 is a NACK for a type three event. A third bit 1906 is an ACK. A fourth bit 1908 is a NACK for a type two event. A fifth bit 1910 is an ACK. A sixth bit 1912 is a NACK for a type three event. According to aspects of the present disclosure, only type one events are considered for bundling. Thus, the UE bundles the first bit 1902, third bit 1906 and fifth bit 1910. The resulting bundled bit 1914 is a NACK.

In a second example 1920 of FIG. 19, an original type-1 HARQ-ACK codebook also includes six ACK/NACK bits. A first bit 1922 is an ACK. A second bit 1924 is a NACK for a type three event. A third bit 1926 is an ACK. A fourth bit 1928 is a NACK for a type two event. A fifth bit 1930 is an ACK, and a sixth bit 1932 is a NACK for a type three event. According to aspects of the present disclosure, only type one events are considered for bundling. Thus, the UE bundles the first bit 1922, third bit 1926 and fifth bit 1930. The resulting bundled bit 1934 is an ACK.

At the network side, if the bundled bit is an ACK and the number of ACKs do not match the number expected by the network, the network knows that one or more DCI are missing. However, the network node may not know the particular DCI messages that are missing. Hence, the network treats the bundled bit as a NACK. Consequently, the network either reschedules PDSCHs or requests an unbundled HARQ-ACK retransmission.

Details for signaling the information related to the quantity of ACKs is now discussed. In some aspects, the information related to the number of ACKs is the quantity of ACKs modulo a value M, where M is a fixed value or an RRC signaled value. Defining the information related to the number of ACKs as the quantity of ACKs modulo a value M reduces signaling overhead, and the size of the information related to the number of ACKs remains fixed. This technique operates well, as long as a quantity of missed DCIs is smaller than the value M. In some implementations, the value of M=4.

Two options are now described for how to indicate the information related to the number of ACKs. In a first option, option 1, the UE transmits the information related to the number of ACKs separate from the bundling result. For the first option, log₂ M bits are needed plus one bit for the bundling result. In this case, the value of M may be a power of 2, such as 2, 4, 8, . . . . In a first alternative, the information related to the number of ACKs is only indicated if the bundled bit indicates all ACK, for example, the bundled bit is ‘1’. In a second alternative, the UE indicates the information related to the number of ACKs regardless of whether the bundled bit is ACK or NACK.

In a second option, option 2, the UE jointly encodes the information related to the number of ACKs with the bundling bit. That is, a given codepoint jointly indicates the information related to the number of ACKs and the bundling result. In the second option, log₂(M+1) bits are needed, where one codepoint indicates the bundled result is NACK and the remaining codepoints indicate the number of ACKs if the bundled result is ACK. Hence, the bundling result is effectively indicated based on whether the first codepoint or one of the remaining codepoints is indicated, and the indication of the number of ACKs is conditioned on the bundling result being an ACK. This second option is motivated by the fact that the number of ACKs is not critical if the bundled result is NACK. Missing DCIs would not have changed the bundled result. In this second option, the value of M may be a power of 2 minus 1, such as 3, 7, . . . .

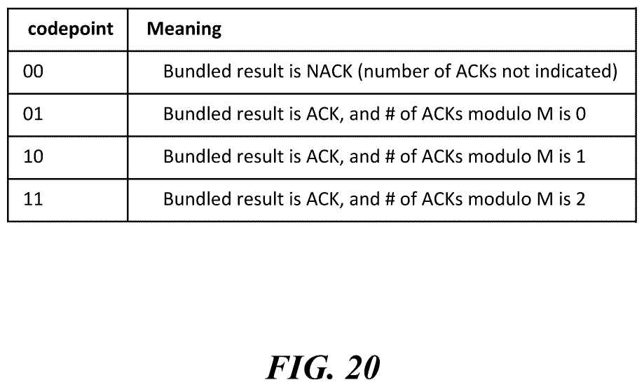

FIG. 20 is a table illustrating example codepoints for jointly encoding a bundling result and information related to a number of ACKs, in accordance with various aspects of the present disclosure. In the example of FIG. 20, assume the value M=3, and hence two bits are needed for four codepoints. A first codepoint 00 may indicate the bundled result is NACK and the number of ACKs is not indicated. A second codepoint 01 indicates the bundled result is ACK and the number of ACKs modulo 3 is 0. A third codepoint 10 indicates the bundled result is ACK and the number of ACKs modulo 3 is 1. A fourth codepoint 11 indicates the bundled result is ACK and the number of ACKs modulo 3 is 2.

Techniques will now be described for cases when the two part HARQ-ACK (scheme 1) is configured. If part one of the two part HARQ-ACK codebook indicates the bundled result is NACK, then the UE sends the entire original type-1 HARQ-ACK codebook in part two, even though for bundling in part one, only a subset of bits is considered, as discussed with reference to FIG. 19. Hence, the indication of the number of ACKs has little value if the bundled result is NACK.

A first solution (solution 1) for the first scheme is based on option 1, alternative one. That is, the UE transmits the information related to the number of ACKs separate from the bundling result. The information related to the number of ACKs is only indicated if the bundled bit indicates all ACK. More specifically, the indication of the number of ACKs is sent in part two if part one indicates that the bundled result is ACK. As discussed before, for a two part HARQ-ACK codebook, part one and part two are separately encoded (e.g., channel encoding). Hence, in this solution, the encoding of the bundling result and the encoding of the indication of the number of ACKs are also separate.

A second solution (solution 2) is based on option 2, that is, the UE jointly indicates (through a joint codepoint as discussed in Option 2) the information related to the number of ACKs with the bundling bit. In this second solution, the indication of the number of ACKs is sent in part one if the bundled result is ACK.

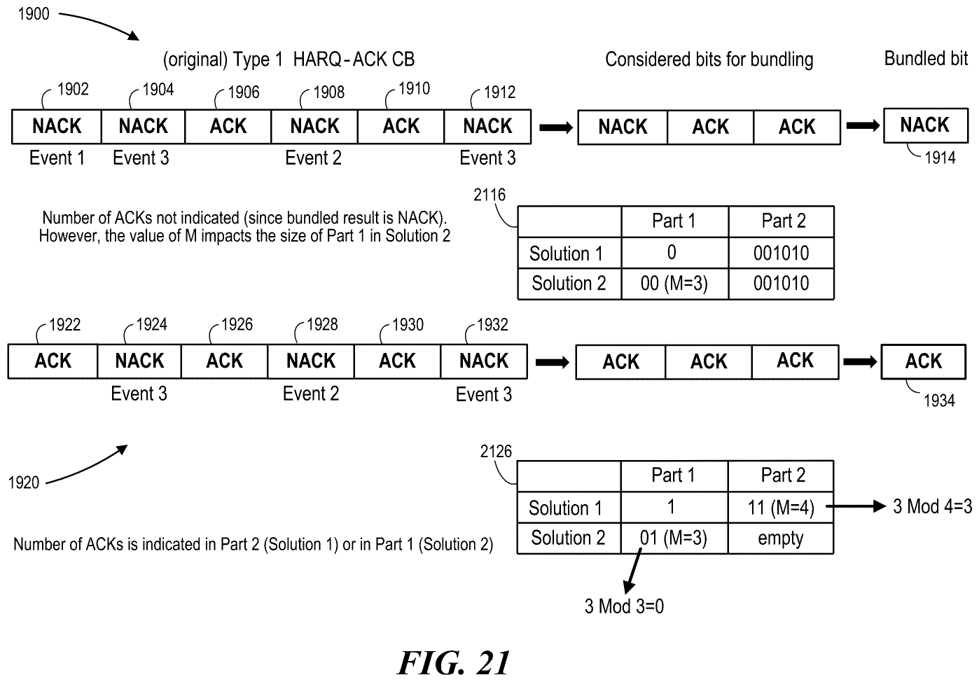

FIG. 21 illustrates examples of reporting a number of ACKs with two part HARQ-ACK compression, in accordance with various aspects of the present disclosure. In a first example 1900 of FIG. 21, which is the same as the first example 1900 in FIG. 19, an original type-1 HARQ-ACK codebook includes six ACK/NACK bits. A first bit 1902 is a NACK for a type one event. A second bit 1904 is a NACK for a type three event. A third bit 1906 is an ACK. A fourth bit 1908 is a NACK for a type two event. A fifth bit 1910 is an ACK. A sixth bit 1912 is a NACK for a type three event. According to aspects of the present disclosure, only type one events for NACKs are considered for bundling. Thus, the first bit 1902, third bit 1906 and fifth bit 1910 are considered. The resulting bundled bit 1914 is a NACK.

According to aspects of the present disclosure, the UE does not indicate the number of ACKs in the first example 1900 because the resulting bundled bit 1914 is NACK. As seen in a table 2116, for solution 1, the bit in part one is a 0. The bits for part two correspond to the original HARQ-ACK codebook, that is 001010. The value of M impacts the size of part one in solution 2. Thus, as seen in the table 2116 for solution 2, the two bits for part one are 00, indicating the bundling result is NACK. The bits for part two are the same as with solution 1, that is 001010.

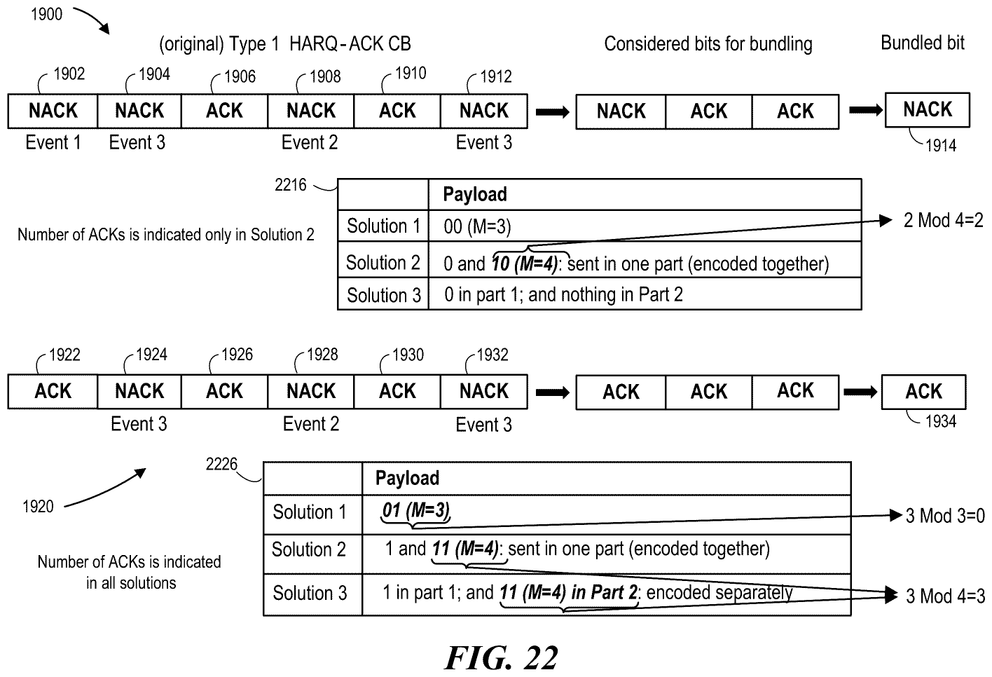

In a second example 1920 of FIG. 22, which is the same as the second example 1920 in FIG. 19, an original type-1 HARQ-ACK codebook includes six ACK/NACK bits. A first bit 1922 is an ACK. A second bit 1924 is a NACK for a type three event. A third bit 1926 is an ACK. A fourth bit 1928 is a NACK for a type two event. A fifth bit 1930 is an ACK. A sixth bit 1932 is a NACK for a type three event. According to aspects of the present disclosure, only type one events for NACKs are considered for bundling. Thus, the first bit 1922, third bit 1926 and fifth bit 1930 are considered. The resulting bundled bit 1934 is an ACK.

As seen in a table 2126, the UE indicates the number of ACKs in part two (for solution 1) or in part one (for solution 2). More specifically, for solution 1, the bit in part one is 1, representing an ACK. The bits in part two are 11 (derived from the table in FIG. 20), which corresponds to 3 MOD 4=3, when the value M=4. For solution 2, where the value M=3, the part one bits are 01 (derived from the table in FIG. 20) because 3 MOD 3=0. There are no bits carried in part two for solution 2 given that the bundling result is ACK.

Aspects will now be described for cases when lossy compression with bundling (scheme 2) is configured. In the case of lossy compression with bundling, even if the bundling result is NACK, the indication of the number of ACKs has value even though the number of ACKs may not be critical.

A first solution (solution 1) for the second scheme is based on option 2, that is, the UE jointly indicates the information related to the number of ACKs with the bundling bit. A second solution (solution 2) for the second scheme is based on option 1, alternative two, that is, the UE transmits the information related to the number of ACKs separate from the bundling result. The information related to the number of ACKs is indicated regardless of the value of the bundled bit.

A third solution (solution 3) is based on option 1, alternative one. That is, the UE transmits the information related to the number of ACKs separate from the bundling result. The information related to the number of ACKs is only indicated if the bundled bit indicates all ACKs. In the third solution, the UE transmits HARQ-ACK feedback in two parts, similar to scheme 1 (two part HARQ-ACK). However, unlike scheme 1, the compression in the third solution is lossy. The purpose of part two is to only send the indication of the number of ACKs when needed. In contrast to scheme 1 (two part HARQ-ACK), the purpose of part two here (in solution 3 of scheme 2) is not to indicate the full HARQ-ACK information when the bundling result is NACK. The indication of the number of ACKs is sent in part two only if part one indicates that the bundled result is ACK. In the third solution, there is no part two if the bundled result is NACK (unlike in scheme 1). The encoding (e.g., channel encoding) for part one and part two are separate (similar to scheme 1). Hence, in this solution, the encoding of the bundling result and the encoding of the indication of the number of ACKs are separate.

FIG. 22 illustrates examples of reporting a number of ACKs for lossy compression with bundling, in accordance with various aspects of the present disclosure. In a first example 1900 of FIG. 22, which is the same as the first example 1900 in FIG. 19, an original type-1 HARQ-ACK codebook includes six ACK/NACK bits. A first bit 1902 is a NACK for a type one event. A second bit 1904 is a NACK for a type three event. A third bit 1906 is an ACK. A fourth bit 1908 is a NACK for a type two event. A fifth bit 1910 is an ACK. A sixth bit 1912 is a NACK for a type three event. According to aspects of the present disclosure, only type one events for NACKs are considered for bundling. Thus, the first bit 1902, third bit 1906 and fifth bit 1910 are considered. The resulting bundled bit 1914 is a NACK.

According to aspects of the present disclosure, the number of ACKs is indicated only in solution 2 for the first example 1900. That is, the UE transmits the information related to the number of ACKs separate from the bundling result. The information related to the number of ACKs is indicated regardless of the value of the bundled bit. As seen in a table 2216, for the first solution, the payload is 00 indicating that the bundling result is NACK based on a joint codepoint, where the value M=3. For solution 2, the payload is 0 and 10 because 2 MOD 4=2, where the value M=4. The UE transmits the values in one part, in other words, the values are encoded (e.g., channel encoding) together. For solution 3, the UE transmits 0 in part one and no bits in part two given that bundling result is NACK.

In a second example 1920 of FIG. 22, which is the same as the second example 1920 in FIG. 19, an original type-1 HARQ-ACK codebook includes six ACK/NACK bits. A first bit 1922 is an ACK. A second bit 1924 is a NACK for a type three event. A third bit 1926 is an ACK. A fourth bit 1928 is a NACK for a type two event. A fifth bit 1930 is an ACK. A sixth bit 1932 is a NACK for a type three event. According to aspects of the present disclosure, only type one events for NACKs are considered for bundling. Thus, the first bit 1922, third bit 1926 and fifth bit 1930 are considered. The resulting bundled bit 1934 is an ACK.

In this second example 1920, the number of ACKs is indicated in all solutions because the resulting bundled bit 1934 is ACK. Referring to a table 2226 in FIG. 22, the UE transmits 01 for the first solution where the value M=3 because 3 MOD 3=0. For the second solution, the UE jointly encodes (e.g., channel encoding) the values 1 (e.g., bundling results) and 11 (e.g., number of ACKs), because 3 MOD 4=3 where the value M=4. For solution 3, the UE transmits 1 in part one and separately transmits 11 in part two because 3 MOD 4=3 where the value M=4. The channel encoding for part one and part two is also separate.

According to further aspects of the present disclosure, instead of reporting the number of ACKs of a bundling result, the UE reports the number of bits, ACK or NACK, that are bundled together. Note, that if the bundled result is ACK (e.g., 1), there is no difference between the number of ACKs versus the number of bundled bits. However, if the bundled result is NACK (e.g., 0), these two values can be different, as seen in the first example 1900 of FIG. 19.

In the second option, where the UE jointly indicates the information related to the number of ACKs with the bundling bit, the UE does not report a number if the bundled result is NACK. Hence, this proposal is not applicable.

Similarly, in option 1, first alternative, where the UE transmits the information related to the number of ACKs separate from the bundling result only when the bundling result is ACK, the UE does not report the information related to the number of ACKs if the bundled result is NACK. Hence, this proposal is not applicable.

In option 1, second alternative, where the UE transmits the information related to the number of ACKs separate from the bundling result regardless of whether the bundled bit is ACK or NACK, the two values can be different. In the first example 1900 of FIG. 19, the UE reports three as the number of bundled bits instead of the number of ACKs, which is two.

Although the preceding description refers to HARQ-ACK. Any other type of ACK is also contemplated.

FIG. 23 is a flow diagram illustrating an example of modifying a HARQ-ACK payload prior to forming two HARQ-ACK parts, in accordance with various aspects of the present disclosure. The operations of the process 2300 may be implemented by a UE, such as a UE 120 described with reference to FIGS. 1-4. As shown in the example of FIG. 23, the process 2300 begins at block 2302 by receiving, from a network node, a group of downlink transmissions. At block 2304, the process 2300 forms, from an original HARQ-ACK payload, a first HARQ-ACK part and a second HARQ-ACK part in accordance with satisfying a forming condition, the original HARQ-ACK payload including HARQ feedback for each one of the group of downlink transmissions, a size of the second HARQ-ACK part being a function of the first HARQ-ACK part. At block 2306, the process 2300 separately encodes the first HARQ-ACK part and the second HARQ-ACK part. At block 2308, the process 2300 transmits the encoded first HARQ-ACK part and the encoded second HARQ-ACK part.

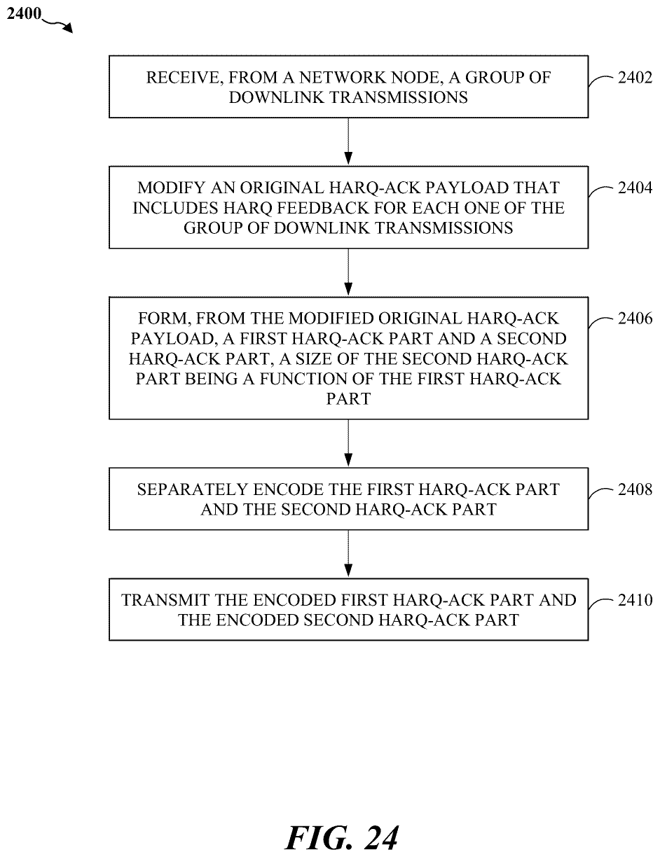

FIG. 24 is a flow diagram illustrating an example of modifying a HARQ-ACK payload prior to forming two HARQ-ACK parts, in accordance with various aspects of the present disclosure. The operations of the process 2400 may be implemented by a UE, such as a UE 120 described with reference to FIGS. 1-4. As shown in the example of FIG. 24, the process 2400 begins at block 2402 by receiving, from a network node, a group of downlink transmissions. At block 2404, the process 2400 modifies an original HARQ-ACK payload that includes HARQ feedback for each one of the group of downlink transmissions. At block 2406, the process 2400 forms, from the modified original HARQ-ACK payload, a first HARQ-ACK part and a second HARQ-ACK part, a size of the second HARQ-ACK part being a function of the first HARQ-ACK part. At block 2408, the process 2400 separately encodes the first HARQ-ACK part and the second HARQ-ACK part. At block 2410, the process 2400 transmits the encoded first HARQ-ACK part and the encoded second HARQ-ACK part.

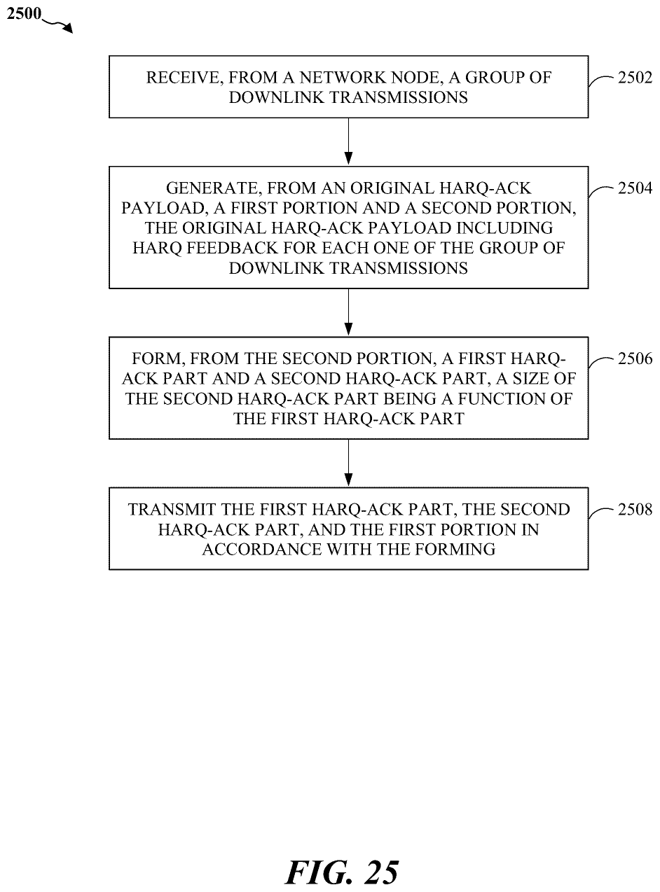

FIG. 25 is a flow diagram illustrating an example of modifying a HARQ-ACK payload prior to forming two HARQ-ACK parts, in accordance with various aspects of the present disclosure. The operations of the process 2500 may be implemented by a UE, such as a UE 120 described with reference to FIGS. 1-4. As shown in the example of FIG. 25, the process 2500 begins at block 2502 by receiving, from a network node, a group of downlink transmissions. At block 2504, the process 2500 generates, from an original HARQ-ACK payload, a first portion and a second portion, the original HARQ-ACK payload including HARQ feedback for each one of the group of downlink transmissions. At block 2506, the process 2500 forms, from the second portion, a first HARQ-ACK part and a second HARQ-ACK part, a size of the second HARQ-ACK part being a function of the first HARQ-ACK part. At block 2508, the process 2500 transmits the first HARQ-ACK part, the second HARQ-ACK part, and the first portion in accordance with the forming.

Implementation examples are described in the following numbered clauses:
Clause 1. A method for wireless communication by a UE, comprising: receiving, from a network node, a group of downlink transmissions; forming, from an original HARQ-ACK payload, a first HARQ-ACK part and a second HARQ-ACK part in accordance with satisfying a forming condition, the original HARQ-ACK payload including HARQ feedback for each one of the group of downlink transmissions, a size of the second HARQ-ACK part being a function of the first HARQ-ACK part; separately encoding the first HARQ-ACK part and the second HARQ-ACK part; and transmitting the encoded first HARQ-ACK part and the encoded second HARQ-ACK part.
Clause 2. The method of Clause 1, wherein the forming condition is semi-statically configured via a radio resource control (RRC) message or dynamically configured.
Clause 3. The method of Clause 2, wherein: the forming condition is semi-statically configured; and the forming condition is satisfied in accordance with the original HARQ-ACK payload being a type 2 payload.
Clause 4. The method of Clause 2, wherein: the forming condition is dynamically configured; and the forming condition is satisfied in accordance with the original HARQ-ACK payload being a type 2 payload and the network node refraining from requesting a type 3 payload.
Clause 5. The method of any one of Clauses 1-3, wherein the forming condition is satisfied based on a code block group (CBG)-based physical downlink shared channel (PDSCH) reception being disabled.
Clause 6. The method of any one of Clauses 1-3, wherein the forming condition is satisfied based on a maximum quantity of codewords per physical downlink shared channel (PDSCH) being less than or greater than a threshold.
Clause 7. The method of any one of Clauses 1-3, wherein the forming condition is satisfied based on spatial bundling being enabled.
Clause 8. The method of any one of Clauses 1-3, wherein the forming condition is satisfied based on all negative acknowledgements (NACKs) included the original HARQ-ACK payload being NACKs associated with a decoding failure.
Clause 9. The method of any one of Clauses 1-8, further comprising: refraining from forming the first HARQ-ACK part and the second HARQ-ACK part in accordance with failing to satisfy the forming condition; and transmitting the original HARQ-ACK payload in accordance with refraining from forming the first HARQ-ACK part and the second HARQ-ACK part.
Clause 10. The method of any one of Clauses 1-9, further comprising receiving, from the network node, one or more downlink control information (DCI), wherein a final DCI of the one or more DCI indicates whether to form the first HARQ-ACK part and the second HARQ-ACK part.
Clause 11. A method for wireless communication by a UE, comprising: receiving, from a network node, a group of downlink transmissions; modifying an original HARQ-ACK payload that includes HARQ feedback for each one of the group of downlink transmissions; forming, from the modified original HARQ-ACK payload, a first HARQ-ACK part and a second HARQ-ACK part, a size of the second HARQ-ACK part being a function of the first HARQ-ACK part; separately encoding the first HARQ-ACK part and the second HARQ-ACK part; and transmitting the encoded first HARQ-ACK part and the encoded second HARQ-ACK part.
Clause 12. The method of Clause 11, wherein: modifying the original HARQ-ACK payload comprises modifying each default negative acknowledgement (NACK) in a set of information bits to an ACK; and the set of information bits are associated with a transport block in the original HARQ-ACK payload.
Clause 13. The method of Clause 11, wherein modifying the original HARQ-ACK payload comprises generating an ACK for a second transport block in the original HARQ-ACK payload.
Clause 14. The method of Clause 11, wherein modifying the original HARQ-ACK payload comprises modifying each default negative acknowledgements (NACK) in the original HARQ-ACK payload to an ACK.
Clause 15. The method of Clause 11, wherein modifying the original HARQ-ACK payload comprises generating an ACK for each bit of a set of information bits associated with a transport block in the original HARQ-ACK payload.
Clause 16. A method for wireless communication by a UE, comprising: receiving, from a network node, a group of downlink transmissions; generating, from an original HARQ-ACK payload, a first portion and a second portion, the original HARQ-ACK payload including HARQ feedback for each one of the group of downlink transmissions; forming, from the second portion, a first HARQ-ACK part and a second HARQ-ACK part, a size of the second HARQ-ACK part being a function of the first HARQ-ACK part; and transmitting the first HARQ-ACK part, the second HARQ-ACK part, and the first portion in accordance with the forming.
Clause 17. The method of Clause 16, wherein: the original HARQ-ACK payload is a type 3 payload; the first portion includes one or more new data indicators (NDIs); and the second portion includes the HARQ feedback.
Clause 18. The method of Clause 16, wherein: the original HARQ-ACK payload is a type 2 payload associated with two sub-codebooks; a first sub-codebook is a transport block based sub-codebook and a second sub-codebook is a codebook group based sub-codebook; the first portion is the second sub-codebook; and the second portion is the first sub-codebook.
Clause 19. The method of any one of Clauses 16-18, further comprising jointly encoding the first portion and the first HARQ-ACK part.
Clause 20. The method of any one of Clauses 16-18, further comprising jointly encoding the first portion and the second HARQ-ACK part.
Clause 21. The method of any one of Clauses 16-18, further comprising separately encoding the first portion, the first HARQ-ACK part, and the second HARQ-ACK part.

The foregoing disclosure provides illustration and description, but is not intended to be exhaustive or to limit the aspects to the precise form disclosed. Modifications and variations may be made in light of the above disclosure or may be acquired from practice of the aspects.

As used, the term “component” is intended to be broadly construed as hardware, firmware, and/or a combination of hardware and software. As used, a processor is implemented in hardware, firmware, and/or a combination of hardware and software.

Some aspects are described in connection with thresholds. As used, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described may be implemented in different forms of hardware, firmware, and/or a combination of hardware and software. The actual specialized control hardware or software code used to implement these systems and/or methods is not limiting of the aspects. Thus, the operation and behavior of the systems and/or methods were described without reference to specific software code—it being understood that software and hardware can be designed to implement the systems and/or methods based, at least in part, on the description.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used should be construed as critical or essential unless explicitly described as such. Also, as used, the articles “a” and “an” are intended to include one or more items, and may be used interchangeably with “one or more.” Furthermore, as used, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used, the terms “has,” “have,” “having,” and/or the like are intended to be open-ended terms. Further, the phrase “based on” is intended to mean “based, at least in part, on” unless explicitly stated otherwise.

What is claimed:

1. A method for wireless communication by a UE, comprising:
receiving, from a network node, a group of downlink transmissions;
forming, from an original HARQ-ACK payload, a first HARQ-ACK part and a second HARQ-ACK part in accordance with satisfying a forming condition, the original HARQ-ACK payload including HARQ feedback for each one of the group of downlink transmissions, a size of the second HARQ-ACK part being a function of the first HARQ-ACK part;
separately encoding the first HARQ-ACK part and the second HARQ-ACK part; and
transmitting the encoded first HARQ-ACK part and the encoded second HARQ-ACK part.

2. The method of claim 1, wherein the forming condition is semi-statically configured via a radio resource control (RRC) message or dynamically configured.

3. The method of claim 2, wherein:
the forming condition is semi-statically configured; and
the forming condition is satisfied in accordance with the original HARQ-ACK payload being a type 2 payload.

4. The method of claim 2, wherein:
the forming condition is dynamically configured; and
the forming condition is satisfied in accordance with the original HARQ-ACK payload being a type 2 payload and the network node refraining from requesting a type 3 payload.

5. The method of claim 1, wherein the forming condition is satisfied based on a code block group (CBG)-based physical downlink shared channel (PDSCH) reception being disabled.

6. The method of claim 1, wherein the forming condition is satisfied based on a maximum quantity of codewords per physical downlink shared channel (PDSCH) being less than or greater than a threshold.

7. The method of claim 1, wherein the forming condition is satisfied based on spatial bundling being enabled.

8. The method of claim 1, wherein the forming condition is satisfied based on all negative acknowledgements (NACKs) included the original HARQ-ACK payload being NACKs associated with a decoding failure.

9. The method of claim 1, further comprising:
refraining from forming the first HARQ-ACK part and the second HARQ-ACK part in accordance with failing to satisfy the forming condition; and
transmitting the original HARQ-ACK payload in accordance with refraining from forming the first HARQ-ACK part and the second HARQ-ACK part.

10. The method of claim 1, further comprising receiving, from the network node, one or more downlink control information (DCI), wherein a final DCI of the one or more DCI indicates whether to form the first HARQ-ACK part and the second HARQ-ACK part.

11. A method for wireless communication by a UE, comprising:
receiving, from a network node, a group of downlink transmissions;
modifying an original HARQ-ACK payload that includes HARQ feedback for each one of the group of downlink transmissions;
forming, from the modified original HARQ-ACK payload, a first HARQ-ACK part and a second HARQ-ACK part, a size of the second HARQ-ACK part being a function of the first HARQ-ACK part;
separately encoding the first HARQ-ACK part and the second HARQ-ACK part; and
transmitting the encoded first HARQ-ACK part and the encoded second HARQ-ACK part.

12. The method of claim 11, wherein:
modifying the original HARQ-ACK payload comprises modifying each default negative acknowledgement (NACK) in a set of information bits to an ACK; and
the set of information bits are associated with a transport block in the original HARQ-ACK payload.

13. The method of claim 11, wherein modifying the original HARQ-ACK payload comprises generating an ACK for a second transport block in the original HARQ-ACK payload.

14. The method of claim 11, wherein modifying the original HARQ-ACK payload comprises modifying each default negative acknowledgements (NACK) in the original HARQ-ACK payload to an ACK.

15. The method of claim 11, wherein modifying the original HARQ-ACK payload comprises generating an ACK for each bit of a set of information bits associated with a transport block in the original HARQ-ACK payload.

16. A method for wireless communication by a UE, comprising:
receiving, from a network node, a group of downlink transmissions;
generating, from an original HARQ-ACK payload, a first portion and a second portion, the original HARQ-ACK payload including HARQ feedback for each one of the group of downlink transmissions;
forming, from the second portion, a first HARQ-ACK part and a second HARQ-ACK part, a size of the second HARQ-ACK part being a function of the first HARQ-ACK part; and
transmitting the first HARQ-ACK part, the second HARQ-ACK part, and the first portion in accordance with the forming.

17. The method of claim 16, wherein:
the original HARQ-ACK payload is a type 3 payload;
the first portion includes one or more new data indicators (NDIs); and
the second portion includes the HARQ feedback.

18. The method of claim 16, wherein:
the original HARQ-ACK payload is a type 2 payload associated with two sub-codebooks;
a first sub-codebook is a transport block based sub-codebook and a second sub-codebook is a codebook group based sub-codebook;
the first portion is the second sub-codebook; and
the second portion is the first sub-codebook.

19. The method of claim 16, further comprising jointly encoding the first portion and the first HARQ-ACK part.

20. The method of claim 16, further comprising jointly encoding the first portion and the second HARQ-ACK part.

21. The method of claim 16, further comprising separately encoding the first portion, the first HARQ-ACK part, and the second HARQ-ACK part.

22. A user equipment (UE), comprising:
one or more processors; and
one or more memories coupled with the one or more processors and storing processor-executable code that, when executed by the one or more processors, is configured to cause the UE to:
receive, from a network node, a group of downlink transmissions;
form, from an original HARQ-ACK payload, a first HARQ-ACK part and a second HARQ-ACK part in accordance with satisfying a forming condition, the original HARQ-ACK payload including HARQ feedback for each one of the group of downlink transmissions, a size of the second HARQ-ACK part being a function of the first HARQ-ACK part;
separately encode the first HARQ-ACK part and the second HARQ-ACK part; and
transmit the encoded first HARQ-ACK part and the encoded second HARQ-ACK part.

23. The UE of claim 22, wherein the forming condition is semi-statically configured via a radio resource control (RRC) message or dynamically configured.

24. The UE of claim 23, wherein:
the forming condition is semi-statically configured; and
the forming condition is satisfied in accordance with the original HARQ-ACK payload being a type 2 payload.

25. The UE of claim 23, wherein:
the forming condition is dynamically configured; and
the forming condition is satisfied in accordance with the original HARQ-ACK payload being a type 2 payload and the network node refraining from requesting a type 3 payload.

26. The UE of claim 22, wherein the forming condition is satisfied based on a code block group (CBG)-based physical downlink shared channel (PDSCH) reception being disabled.

27. The UE of claim 22, wherein the forming condition is satisfied based on a maximum quantity of codewords per physical downlink shared channel (PDSCH) being less than or greater than a threshold.

28. The UE of claim 22, wherein the forming condition is satisfied based on spatial bundling being enabled.

29. The UE of claim 22, wherein the forming condition is satisfied based on all negative acknowledgements (NACKs) included the original HARQ-ACK payload being NACKs associated with a decoding failure.

30. The UE of claim 22, execution of the processor-executable code further cause the UE to:
refrain from forming the first HARQ-ACK part and the second HARQ-ACK part in accordance with failing to satisfy the forming condition; and
transmit the original HARQ-ACK payload in accordance with refraining from forming the first HARQ-ACK part and the second HARQ-ACK part.
